(19) United States
(12) Patent Application Publication
(10) Pub. No.: US 2026/0244599 A1
(43) Pub. Date: Aug. 20, 2026

(54) SYSTEMS AND METHODS FOR COMPRESSION AND CRYPTOGRAPHY

(71) Applicant: LOUD BARK SOFTWARE LLC, Minneapolis, MN (US)

(72) Inventor: Huxley Westemeier, Minneapolis, MN (US)

(73) Assignee: LOUD BARK SOFTWARE LLC, Minneapolis, MN (US)

(21) Appl. No.: 19/539,834

(22) Filed: Feb. 13, 2026

Related U.S. Application Data
(60) Provisional application No. 63/758,552, filed on Feb. 14, 2025.

(51) Int. Cl. G06F 16/174; H04L 9/06

(52) U.S. Cl. CPC G06F 16/1744; H04L 9/0618

(57) ABSTRACT

Disclosed herein are systems and methods for encoding and decoding messages using a key file, in which messages are jointly encrypted and compressed or jointly decrypted and decompressed. The encoding process encodes data portions sequentially using a data frequency table generated for a key file. The final encoded message combines the encoded output, where encoded data portions are encoded with variable-lengths assigned according to the frequency table of the key table. The decoding process involves reversing the encoding steps, using the same key file to generate the frequency table for the key file and determining the assigned bytes or data portions assigned to the encoded data using the frequency table.

### CROSS-REFERENCE TO RELATED APPLICATION

This application is a non-provisional application that claims the benefit of and priority to U.S. Provisional Application No. 63/758,552, filed Feb. 14, 2025, which is incorporated by reference in its entirety.

### TECHNICAL FIELD

This application generally relates to computing operations for compression and cryptography. In particular, this application relates to computing operations for jointly compressing and encrypting data.

### BACKGROUND

Symmetric key cryptography involves the use of the same key for both encryption and decryption of data. Symmetric cryptography relies on the secrecy of the key, which must be shared between the communicating parties while remaining concealed from any unauthorized entities. The symmetric key processes are generally efficient, as symmetric key algorithms can quickly encrypt and decrypt large amounts of data. Common algorithms in symmetric key cryptography include AES (Advanced Encryption Standard) and DES (Data Encryption Standard), which have been extensively used in various security protocols.

However, symmetric key systems exhibit vulnerabilities that can be exploited under certain conditions. Repeated use of the same key can lead to the creation of patterns within the encrypted output, sometimes referred to as “ciphertext,” which can be analyzed to deduce the key and decrypt the encrypted messages in future ciphertext. This pattern recognition was famously used to crack the Enigma machine by identifying predictable terms within the ciphertext.

Additionally, compressing data before encryption can introduce detectable structures, such as headers and footers, which compromise the integrity of the encrypted data. Existing approaches to compressing data typically add these structures, which can be detected or deduced through pattern recognition in the encrypted outputs. These shortcomings necessitate the development of more robust approaches to secure data encryption.

### SUMMARY

Embodiments disclosed herein address the shortcomings in cryptography and compression by introducing a computer-implemented method and systems execute operations that simultaneously compresses and encrypts data, thereby avoiding the creation of patterns that can be exploited to deduce keys. The approach utilizes variable-length encoding, assigning smaller compressed sizes to frequently occurring characters based on the frequencies from a secondary key file. This method significantly increases the difficulty of pattern recognition and decryption, even with advanced computing capabilities, by exponentially expanding the range of possible keys, thus providing a more robust and secure data encryption solution.

In some aspects, the techniques described herein relate to a computer-implemented method for compressing and encrypting data, the method including: obtaining, by a computer, a frequency table indicating a plurality of frequencies of occurrence for a plurality of key bytes of a key file and a cleartext file including a plurality of input bytes to be encoded using the key file; encoding, by the computer, the plurality of input bytes of the input file using the frequency table from the key file, for each input byte the computer generates a code having a bit-length based upon the frequency of occurrence of the input byte as indicated by the frequency table, thereby generating a plurality of codes having variable bit-lengths for the plurality of input bytes; and generating, by the computer, an encoded file for the cleartext file including the plurality of codes having the variable bit-lengths generated for the plurality of input bytes.

In some aspects, the techniques described herein relate to a method, wherein the computer encodes the cleartext file based upon the frequency table using an asymmetric numeral system (ANS).

In some aspects, the techniques described herein relate to a method, further including generating, by the computer, a plurality of key bytes representing at least a portion of the key file.

In some aspects, the techniques described herein relate to a method, further including generating, by the computer, a plurality of input bytes representing the cleartext file.

In some aspects, the techniques described herein relate to a method, further including determining, by the computer, a frequency of each key byte of the plurality key bytes, thereby generating a frequency table for the plurality of key bytes indicating the frequency of each byte occurring in a portion of the key file.

In some aspects, the techniques described herein relate to a computer-implemented method for jointly decompressing and decrypting data, the method including: obtaining, by a computer, an encoded file including a plurality of codes having variable bit-lengths and a frequency table indicating a plurality of frequencies of occurrence for a plurality of key bytes of a key file; decoding, by the computer, the plurality of codes of the encoded file using the frequency table, for each code the computer determines a decrypted byte having a standard length based upon a frequency of occurrence of the code as indicated by the frequency table, thereby generating a plurality of decrypted bytes having the standard length for the plurality of codes; and generating, by the computer, a decrypted file for the encoded file including the plurality of decrypted bytes having the standard length generated for the plurality of codes.

In some aspects, the techniques described herein relate to a method, wherein the computer decodes the encoded file based upon the frequency table using an asymmetric numeral system (ANS).

In some aspects, the techniques described herein relate to a method, further including generating, by the computer, a plurality of key bytes representing at least a portion of the key file.

In some aspects, the techniques described herein relate to a method, further including generating, by the computer, a plurality of encoded bytes representing the encoded file.

In some aspects, the techniques described herein relate to a method, further including generating, by the computer, the frequency table based on the plurality of key bytes of the key file, for each key byte of the plurality of key bytes the frequency table indicates a frequency of occurrence of the key byte in the plurality of key bytes.

In some aspects, the techniques described herein relate to a computer-implemented method for compressing and encrypting input data using authenticating data, the method including: obtaining, by a computer, a password and message randomness data including a salt and a nonce; executing, by the computer, a key derivation function on the password and the message randomness data to generate a plurality of subkeys for controlling keyed transformations and authentication; executing, by the computer during encoding of a cleartext file including input bytes, a keyed permutation to symbol-to-interval mappings within one or more cumulative frequency table based on one or more subkeys; performing, by the computer during encoding, a keyed residue shift on one or more remainder values in range asymmetric numeral system using a second subkey; executing, by the computer, an entropy model on the cleartext file with adaptive frequency counts based on a third subkey; encoding, by the computer, the plurality of input bytes using the keyed transformations and the frequency table according to an adaptive context model to produce variable bit-length codes; masking, by the computer, an encoded output and a final state with a keyed keystream, thereby generating a masked payload for an encoded data file for the cleartext file; generating, by the computer, a message authentication code (MAC) computed over the salt, nonce, the masked payload, and the final state using a fourth subkey; and generating, by the computer, the encoded file including the masked payload and the authentication data.

In some aspects, the techniques described herein relate to a method, wherein the key derivation function includes a memory-hard password-based key derivation function configured to incorporate the salt and nonce to ensure per-message uniqueness and cryptographic strength.

In some aspects, the techniques described herein relate to a method, wherein executing the keyed permutation to the symbol-to-interval mappings includes seeding, by the computer, a pseudorandom number generator with the one or more subkeys, a context identifier, and the nonce.

In some aspects, the techniques described herein relate to a method, further including using an explicit end-of-file (EOF) symbol within the entropy model to signal termination of encoding, replacing any prior unit counting or length tracking mechanisms.

In some aspects, the techniques described herein relate to a computer-implemented method for jointly decompressing and decrypting input data using authenticating data, the method including: obtaining, by a computer, an encoded file including a masked payload and authentication data, a password, and message randomness data including a salt and a nonce; executing, by the computer, a key derivation function on the password and the message randomness data to generate a plurality of subkeys for controlling keyed transformations and authentication; verifying, by the computer, the authentication data by computing a message authentication code (MAC) over the salt, nonce, masked payload, and an encoded final state, and comparing the computed MAC to the authentication data, proceeding only upon successful verification; unmasking, by the computer, the masked payload and the encoded final state using a keyed keystream generated from the plurality of subkeys; generating, by the computer, a frequency table having adaptive frequency counts based on a subkey, and applying a keyed permutation to symbol-to-interval mappings within one or more cumulative frequency tables for a context according to a subkey; decoding, by the computer, the unmasked payload using a range asymmetric numeral system (rANS) decoder incorporating a keyed residue shift reversal on remainder values in accordance with a derived subkey and the frequency table having the adaptive frequency counts, thereby generating decoded bytes for a decrypted file; generating, by the computer, the decrypted file including the decoded bytes.

In some aspects, the techniques described herein relate to a method, wherein the key derivation function includes a memory-hard password-based key derivation function configured to incorporate the salt and nonce to ensure per-message uniqueness and cryptographic strength.

In some aspects, the techniques described herein relate to a method, wherein the verification of the MAC prevents decoding when an incorrect password is provided or when the encoded file has been tampered with.

In some aspects, the techniques described herein relate to a method, further including generating, by the computer during decoding, a keyed residue shift reversal offset dynamically based on a pseudorandom sequence derived from one or more subkeys and the nonce, wherein the offset is applied to remainder values to reverse the keyed residue shifts applied during encoding.

In some aspects, the techniques described herein relate to a method, further including adaptively updating the context after decoding each symbol to maintain synchronization of an adaptive context model used in encoding and decoding.

In some aspects, the techniques described herein relate to a method, wherein decoding outputs plaintext only upon successful MAC verification and correct key usage, thereby preventing partial or incorrect decryption of the encoded data.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components and dataflow of a system for securely exchanging and storing data files using compression operations for jointly compressing and encrypting data, according to embodiments.

FIG. 2 is a flowchart of operations of a computer-implemented method for encoding (e.g., jointly compressing and encrypting) cleartext input data of a cleartext data file or data stream, according to embodiments.

FIG. 3 is a flowchart of operations of a computer-implemented method for decoding (e.g., jointly decompressing and decrypting) ciphertext input data of a ciphertext data file or data stream, according to embodiments.

FIG. 4 is a flowchart of operations of a method for jointly compressing and encrypting data, according to embodiments.

FIG. 5 shows dataflow amongst components of a system for compressing and encrypting data using variable-length compression operations and steganography, according to embodiments.

FIG. 6 shows operations of a computer-implemented method for compressing and encrypting input data using authenticating data, according to embodiments.

FIG. 7 shows operations of a computer-implemented method for jointly decompressing and decrypting input data using authenticating data, according to embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Symmetric key systems are susceptible to certain vulnerabilities that can be exploited. The repeated use of the same key may result in patterns within the encrypted output, often referred to as “ciphertext.” These patterns can be analyzed to deduce the key and thereby decrypt future ciphertext messages.

Furthermore, compressing data prior to encryption can introduce identifiable structures, such as headers and footers, which compromise the integrity of the encrypted data. Standard data compression methods typically incorporate these structures, making them detectable through pattern recognition in the encrypted outputs. These limitations highlight the need for the development of more robust data encryption techniques.

Embodiments described herein provide an improved approach to compressing and encrypting data. Rather than representing one piece of data (e.g., character, byte) in the input data as one byte in the output data, embodiments herein perform compression operations implementing variable-length encoding, such that one word in the input might be two bytes, and the next word might be three or four bytes. A symbol in the input is not always equal to one symbol in the output, which avoids producing patterns in the encrypted data and obfuscates patterns that might exist in the original data or metadata.

Symmetric key cryptography involves the use of the same key for both encryption and decryption of data. Symmetric cryptography relies on the secrecy of the key, which must be shared between the communicating parties while remaining concealed from any unauthorized entities. The symmetric key processes are generally efficient, as symmetric key algorithms can quickly encrypt and decrypt large amounts of data. Common algorithms in symmetric key cryptography include Advanced Encryption Standard (AES) and Data Encryption Standard (DES), which have been extensively used in various security protocols. Data compression techniques can reduce the size of digital files by encoding information using fewer bits than the original representation. Compression algorithms can analyze the statistical properties of input data to identify redundancies and patterns that can be represented more compactly. Various compression techniques exist, including lossless compression methods that allow perfect reconstruction of original data and lossy compression methods that trade fidelity for greater size reduction. Compression can be applied to many types of data, including text files, images, audio, and video.

However, symmetric key systems exhibit vulnerabilities that can be exploited under certain conditions. Repeated use of the same key can lead to the creation of patterns within the encrypted output, sometimes referred to as ciphertext. These patterns can be analyzed to deduce the key and decrypt the encrypted messages in future ciphertext. This pattern recognition was famously used to crack the Enigma machine by identifying predictable terms within the ciphertext. Additionally, compressing data before encryption can introduce detectable structures, such as headers and footers, which compromise the integrity of the encrypted data. Existing approaches to compressing data typically add these structures, which can be detected or deduced through pattern recognition in the encrypted outputs. Standard compression methods may also create identifiable patterns in the compressed data that persist after encryption, potentially revealing information about the underlying plaintext. These shortcomings necessitate the development of more robust approaches to secure data encryption.

The techniques described herein address the shortcomings in cryptography and compression by introducing operations that simultaneously compress and encrypt data, thereby avoiding the creation of patterns that can be exploited to deduce keys. The approach utilizes variable-length encoding that assigns smaller compression sizes to more-frequently occurring data based on the frequencies of such data occurring from a key file. By deriving frequency information from a separate key file rather than from the actual data to be compressed, the techniques described herein can jointly perform compression and encryption in a single process. The variable-length codes assigned to input data elements can depend on the statistical distribution of bytes in the key file, such that the same input data encoded with different key files produces different encrypted outputs. The techniques described herein can eliminate the need for separate compression and encryption steps, thereby reducing computational overhead and avoiding the introduction of detectable structures between these traditionally separate processes.

To implement the techniques described herein, a computer can obtain a key file and a cleartext file to be encoded. The computer can generate a frequency table based on the bytes of the key file, where the frequency table indicates how often each possible byte value occurs in the key file. The computer can parse the cleartext file into a sequence of input bytes. For each input byte in the cleartext file, the computer can assign a variable-length code based on the frequency of occurrence of that input byte as indicated by the frequency table derived from the key file. Input bytes that occur more frequently in the key file can receive shorter codes, while input bytes that occur less frequently in the key file can receive longer codes. The computer can encode the input bytes using a range asymmetric numeral system that maintains a state value representing the current encoding state. The computer can update the state value for each input byte based on the frequency information from the frequency table. When the state value exceeds a threshold, the computer can emit one or more output bits to an encoded output buffer and adjust the state value accordingly. The computer can generate an encoded file comprising the variable-length codes produced by the encoding process. The encoded file can be transmitted to another computing device or stored in a storage medium for later retrieval and decoding using the same key file.

The techniques described herein can significantly increase the difficulty of pattern recognition and decryption, even with advanced computing capabilities, by exponentially expanding the range of possible key data that can be implemented. By using frequency information derived from a key file rather than from the actual data to be compressed, the techniques described herein can avoid the creation of patterns in the encrypted output that could be analyzed to deduce the key. The variable-length encoding approach can obscure patterns that might exist in the original data or metadata, such that one symbol in the input is not always equal to one symbol in the output. The techniques described herein can eliminate the need to compress data prior to encryption as a separate step, thereby avoiding the introduction of identifiable structures such as headers and footers that could compromise the integrity of the encrypted data. The use of a separate key file for frequency analysis can provide a more robust and secure data encryption solution compared to conventional symmetric key systems that rely solely on a shared secret key. The techniques described herein can provide improved security for data transmission and storage applications by reducing the vulnerability to pattern-based cryptanalysis attacks.

Password-based encryption systems can provide security by deriving cryptographic keys from user-supplied passwords. Password-based key derivation functions can transform a password into a cryptographic key suitable for use with encryption algorithms. Various key derivation functions exist, including memory-hard functions that require significant computational resources to compute, thereby increasing resistance to brute-force attacks. Per-message randomness, such as salts and nonces, can be incorporated into key derivation processes to produce unique keys for each encryption session. Message authentication codes can provide cryptographic verification of data integrity and authenticity by producing a fixed-size tag computed over the message using a secret key. Hash-based message authentication codes can use cryptographic hash functions to generate authentication tags that can detect unauthorized modifications to encrypted data.

However, existing password-based encryption approaches may not adequately address the vulnerabilities associated with repeated use of the same password for encoding multiple messages. When the same password is used to encrypt multiple messages, patterns may emerge in the encrypted outputs that could be exploited by an attacker to gain information about the underlying plaintext or the derived keys. Conventional compression techniques applied before encryption can introduce detectable patterns or structures that persist in the encrypted data, potentially revealing information about the compression algorithm or the structure of the plaintext. Standard symmetric key encryption systems may not incorporate sufficient per-message randomness to prevent attacks that exploit similarities between multiple encrypted messages produced with the same password. Existing approaches may lack integrated mechanisms for jointly compressing and encrypting data while maintaining cryptographic security properties, such that compression and encryption must be performed as separate sequential operations. The separation of compression and encryption operations can create vulnerabilities where patterns introduced during compression remain detectable in the encrypted output. These limitations necessitate the development of improved techniques for password-based encryption that can jointly compress and encrypt data while incorporating per-message randomness and authentication mechanisms.

The techniques described herein provide improved password-based encryption by incorporating key derivation, per-message randomness, keyed transformations, and message authentication into a joint compression and encryption process. The techniques described herein can execute a key derivation function on a password and per-message randomness data, including a salt and a nonce, to generate multiple subkeys that control different aspects of the encoding process. For instance, the key derivation functions may include a memory-hardened, password-based key-derivation function configured to incorporate a salt and/or a nonce to generate keys, ciphertext, or other cryptographic materials or outputs that provide per-message uniqueness and according to a particular cryptographic strength or entropy. The techniques described herein can apply keyed permutations to symbol-to-interval mappings within cumulative frequency tables, such that the internal structure of the frequency tables becomes dependent on a derived subkey and per-message randomness. The techniques described herein can perform keyed residue shifts on remainder values during range asymmetric numeral system encoding operations, introducing key-dependent randomization into the state evolution without altering the probability distribution of symbols or affecting compression efficiency. The techniques described herein can initialize adaptive frequency counts based on a derived subkey, such that the starting frequency distribution used for compression depends on the password and per-message randomness. The techniques described herein can mask the encoded output and final state value with a keyed keystream derived from the password and per-message randomness, thereby preventing structural leakage of patterns in the compressed data. The techniques described herein can generate a message authentication code computed over the salt, nonce, masked payload, and final state using a derived subkey, providing cryptographic verification of data integrity and authenticity.

To implement the techniques described herein, a computer can obtain a password and generate per-message randomness data including a salt and a nonce for a particular encoding session. The computer can execute a memory-hard key derivation function on the password, salt, and nonce to produce a master secret. The computer can derive multiple subkeys from the master secret by applying a key derivation function or pseudorandom function with domain-specific labels that distinguish different subkey purposes. The derived subkeys can include a first subkey for controlling keyed permutations, a second subkey for generating keyed residue shifts, a third subkey for initializing adaptive frequency counts, and a fourth subkey for computing message authentication codes. The computer can execute a keyed permutation during encoding by generating a context-specific seed for each cumulative frequency table using the first subkey, the nonce, and a context identifier. The computer can initialize a pseudorandom number generator with the context-specific seed to produce a permutation order for symbols within the cumulative frequency table. The computer can perform a keyed residue shift during encoding by initializing a keystream generator with the second subkey and the nonce to produce pseudorandom offset values for each symbol occurrence. For each input byte to be encoded, the computer can calculate a shifted remainder by adding a pseudorandom offset value to a remainder value and taking the result modulo the frequency of the input byte. The computer can execute an entropy model with adaptive frequency counts by initializing context-specific frequency tables with non-uniform starting counts derived from the third subkey. The computer can encode input bytes using the keyed transformations and adaptive frequency tables according to an adaptive context model to produce variable bit-length codes. The computer can mask the encoded output and final state value by applying bitwise exclusive-or operations with a keyed keystream generated from a masking subkey and the nonce. The computer can generate a message authentication code by executing a hash-based message authentication code algorithm with the fourth subkey as a key input and a concatenation of the salt, nonce, masked payload, and metadata as a message input. The computer can assemble an encoded file comprising the salt, nonce, masked payload, and message authentication code.

The techniques described herein can provide improved security compared to conventional password-based encryption approaches by incorporating per-message randomness that produces unique encoded outputs for each encoding session, even when the same password and cleartext file are used multiple times. By deriving multiple subkeys from a password through a memory-hard key derivation function, the techniques described herein can provide resistance against brute-force password guessing attacks while enabling different cryptographic operations to use independent keying material. The keyed permutations applied to symbol-to-interval mappings can alter the internal structure of cumulative frequency tables without changing frequency values, such that the compression efficiency remains determined by adaptive frequency counts while the mapping between symbols and intervals becomes dependent on the password and per-message randomness. The keyed residue shifts can introduce key-dependent randomization into the state evolution of the range asymmetric numeral system encoding process without altering the probability distribution of symbols or affecting the compression ratio. The initialization of adaptive frequency counts based on a derived subkey can prevent attackers from gaining information about the cleartext by observing patterns in the initial portion of the encoded output. The masking of the encoded output and final state value with a keyed keystream can prevent structural leakage of patterns that might otherwise reveal information about the compression process or the underlying plaintext. The message authentication code can provide cryptographic verification that the encoded file was produced using the correct password and has not been tampered with, preventing partial or incorrect decryption attempts that could result from using an incorrect password or processing a modified encoded file. The techniques described herein can jointly compress and encrypt data in a single integrated process, avoiding the vulnerabilities associated with applying compression and encryption as separate sequential operations where patterns introduced during compression could remain detectable in the encrypted output. By combining password-based key derivation, per-message randomness, keyed transformations, adaptive context modeling, keystream masking, and message authentication, the techniques described herein can provide a more secure and efficient approach to data protection compared to conventional encryption systems.

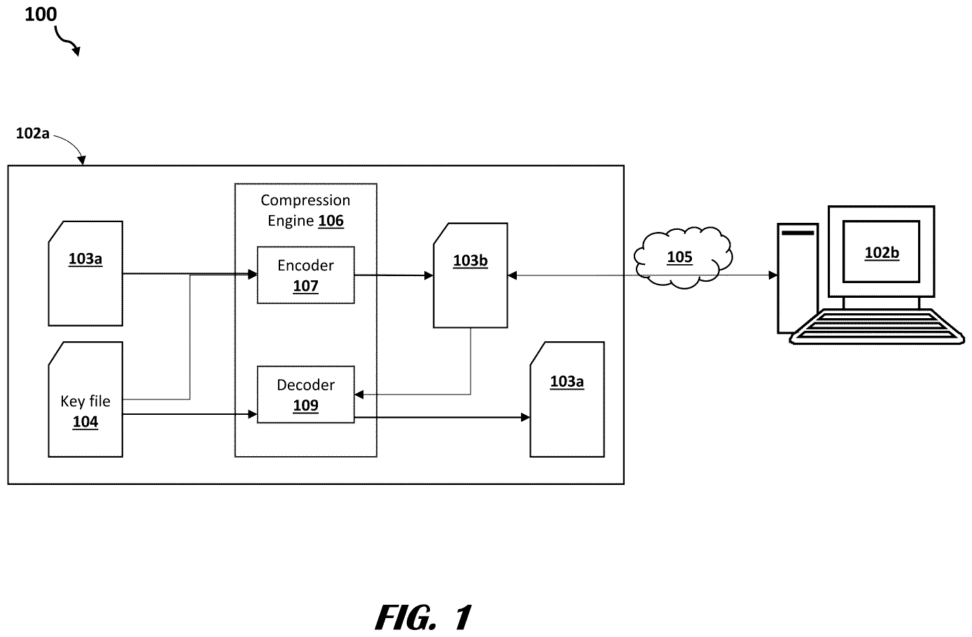

FIG. 1 shows components and dataflow of a system 100 for securely exchanging and storing data files using compression operations for jointly compressing and encrypting data, according to embodiments. The system 100 includes client computers 102a-102b (generally referred to as client computers 102), including a first computer 102a and a second computer 102b, which may communicate via one or more networks 105. The client computers 102 include software programming for a compression engine 106 having software routines of an encoder 107 and a decoder 109.

The client computers 102 may send and receive target files 103a-103b (generally referred to as target files 103), which include a cleartext target file 103a and a compressed-encrypted target file (sometimes referred to as compressed ciphertext target file 103b). The encoder 107 of the compression engine 106 ingests a cleartext target file 103a as an input file and executes various operations for compression using a key file 104 to generate a ciphertext target file 103b as an output file corresponding to the cleartext target file 103a. The decoder 109 of the compression engine 106 ingests a ciphertext target file 103b as an input file and executes various operations for decompression using the key file 104 to generate or otherwise recover a cleartext target file 103a as an output file corresponding to the ciphertext target file 103b. When the first computer 102a sends a target file 103 to the second computer 102b, the first computer 102a executes operations of the compression engine 106 using a cleartext target file 103a as an input file to generate a ciphertext target file 103b corresponding to the cleartext target file 103a. The first computer 102a then transmits the ciphertext target file 103b via the one or more networks 105. Likewise, when the first computer 102a receives a target file 103 from the second computer 102b, the first computer 102a receives a ciphertext target file 103b via the one or more networks 105. The first computer 102a executes operations of the compression engine 106 using the ciphertext target file 103b as an input file to generate or recover the cleartext target file 103a corresponding to the ciphertext target file 103b.

Embodiments may comprise additional or alternative components or omit certain components from those of FIG. 1, and still fall within the scope of this disclosure. It may be common, for example, to include any number of client computers 102 or cloud-based computing systems in which one or more operations described herein are executed on various server computing devices. Embodiments may include or otherwise implement any number of devices capable of performing the various features and tasks described herein.

The networks 105 of the system 100 include hardware and software components for interconnecting the various components of the system 100. The networks 105 may include any number of public networks and/or private networks to interconnect the various components of the system 100. Non-limiting examples of the networks 105 may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

The target files 103 include any type of computing data stored in machine-readable storage medium or actively exchanged between client computers 102. The target files 103 are described as a computing files, but should not be limited to a particular computer file. The target files 103 may include, for example, a data stream from the first computer 102a to the second computer 102b, or a database file stored and retrieved from a database or other storage location. Non-limiting examples of the cleartext target file 103a may include text files, word-processing document files, media files (e.g., audio, video, multimedia), and database records, among others.

The key file 104 includes any type of computing data stored in machine-readable storage medium that the compression engine 106 references during the various operations described herein for performing compression and cryptographic operations. The compression engine 106 references the frequencies of data bytes in the key file 104 to assign variable-length codes to the bytes in the cleartext target file 103a, to generate the ciphertext target file 103b as the output. Certain non-limiting examples of the key file 104 may include text files, multimedia files, database records, or any other computing data stored in a machine-readable storage medium.

The client computers 102 include machine-readable and executable software programming for performing the various operations of the compression engine 106, including the software routines for the encoder 107 and decoder 109. The client computers 102 may include any computing device comprising hardware and software components capable of performing the various operations described herein. Non-limiting examples of the client computers 102 include workstation computers, laptops, tablets, and servers, among others.

In the example system 100, the first computer 102a receives instructions, via a user interface or automated software instructions, to send a cleartext target file 103a to the second computer 102b. The first computer 102a executes the various operations described herein to encode (e.g., compress and encrypt) the cleartext target file 103a and transmits a resulting ciphertext target file 103b to the client computers 102 via the one or more one or more networks 105. Likewise, in the example system 100, the first computer 102a may receive a ciphertext target file 103b from the second computer 102b or from local storage memory and executes the various operations described herein to decode (e.g., decompress and encrypt) the ciphertext target file 103b to recover or restore the cleartext target file 103a. In other embodiments, the first computer 102a may encode and store the ciphertext target file 103b in a local storage memory of the first computer 102a, or encode and store the ciphertext target file 103b at a database hosted at the second computer 102b. Likewise, the first computer 102a may retrieve and decode the ciphertext target file 103b from a local storage memory of the first computer 102a, or retrieve and decode the ciphertext target file 103b from a database hosted at the second computer 102b.

The compression engine 106 of the client computers 102 implement compression operations for a particular compression technique that jointly compresses and encrypts the cleartext target file 103a, or jointly decompresses and decrypts the cleartext target file 103a. In this way, the computer client computers 102 need not execute separate compression and cryptographic operations. In some embodiments, the compression engine 106 implements an Asymmetric Numeral System (ANS) algorithm as the compression technique. The ANS is a highly efficient entropy coding technique used by the compression engine 106 to jointly compress and encrypt the cleartext target file 103a or jointly decompress and decrypt the ciphertext target file 103b. ANS leverages the statistical properties of symbols, assigning shorter codes to more frequent symbols and longer codes to rarer ones, thereby achieving high compression rates. By using the key file 104 for frequency analysis, rather than the actual data of the target files 103, the compression engine 106 accomplishes the compression of ANS and the encryption of the secret key file 104.

The frequency table generated by the compression engine 106 (or other component of the client computers 102) indicates frequencies of data chunks (e.g., bytes) occurring in the key file 104. The frequency table need not be a table format. The frequency table may include any machine-readable data format or file that indicates the frequencies of the data chunks occurring in the key file 104. For instance, the compression engine 106 determines an amount of instances that particular data bytes occur in the key file 104 and generates the frequency table to represent the frequencies of the data bytes. As an example, if the key file 104 contains thirty (30) occurrences of a first byte and ten (10) occurrence of a second byte, then the frequency table generated by the compression engine 106 (or other component of the first computer 102a) will contain data entries that indicate this distribution of frequencies of the first byte and the second byte, and other bytes key file 104. In some implementations, the compression engine 106 generates (or re-generates) the frequency table for the key file 104 at each instance that the compression engine 106 references the key file 104 for encoding or decoding the target file 103. In some implementations, the compression engine 106 generates and stores the frequency table for the key file 104, such that the client computers 102 references the stored frequency table for the key file 104 when encoding or decoding the target file 103.

The encoder 107 of the first computer 102a performs various encoding operations (e.g., compression operations) according to the compression algorithm (e.g., ANS algorithm) implemented by the compression engine 106. When the first computer 102a invokes or calls the encoder 107, the encoder 107 ingests the cleartext target file 103a and the key file 104 as inputs, executes the compression operations, and generates the ciphertext target file 103b as the output.

The encoder 107 may obtain (e.g., receive or retrieve) the cleartext target file 103a and the key file 104 stored at any preconfigured non-transitory storage location accessible to the first computer 102a. The encoder 107 parses data bytes (or key byte) of the key file 104 and generates a frequency table (or other data format) for the key file 104, indicating the frequencies of key bytes. The encoder 107 encodes the cleartext target file 103a by generating and assigning codes to the key bytes, as parsed from the key file 104. The encoder 107 assigns comparatively shorter codes to more frequent key bytes and comparatively longer codes to less frequent key bytes. Using the frequency table, the encoder 107 encodes the cleartext target file 103a by generating and assigning codes to input bytes, as parsed from the cleartext target file 103a. The encoder 107 assigns comparatively shorter codes to more frequent input bytes and comparatively longer codes to less frequent inputs bytes. For example, an input byte that occurs a more frequently may be encoded as four bits, while a less frequently occurring input byte may be encoded as six bits. In this way, the compression is jointly performed with the encryption by using a unique frequency table generated from the secret key file 104. The resulting ciphertext target file 103b is both compressed and encrypted, such that the ciphertext target file 103b can only be correctly decoded (e.g., decompressed and decrypted) using the original frequency table, where the frequency can only be correctly generated using the key file 104. The first computer 102a then transmits the ciphertext target file 103b to the second computer 102b via the one or more one or more networks 105, and the second computer 102b may decode the ciphertext target file 103b using the key file 104, which may be stored in non-transitory machine-readable storage memory of the second computer 102b.

The decoder 109 of the first computer 102a performs the various encoding operations (e.g., compression operations) according to the compression algorithm (e.g., ANS algorithm) implemented by the compression engine 106. When the first computer 102a invokes or calls the decoder 109, the decoder 109 ingests the ciphertext target file 103b and the key file 104 as inputs, executes the compression operations, and generates or otherwise recovers the cleartext target file 103a as the output.

The decoder 109 obtains (e.g., receive or retrieve) the key file 104 stored in the storage memory of the first computer 102a, and may obtain the ciphertext target file 103b from the second computer 102b or local storage memory. The decoder 109 parses key bytes of the key file 104 and generates a frequency table (or other data format) for the key file 104, indicating the frequencies of key bytes. The decoder 109 decodes the ciphertext target file 103b by generating and assigning codes to the key bytes, as parsed from the key file 104. The decoder 109 assigns the comparatively shorter codes to the more frequent key bytes and the comparatively longer codes to the less frequent key bytes. Using the frequency table, the decoder 109 decodes the ciphertext target file 103b by generating and assigning the codes to input bytes, as parsed from the ciphertext target file 103b. The decoder 109 assigns the comparatively shorter codes to more frequent input bytes and the comparatively longer codes to less frequent inputs bytes. The resulting cleartext target file 103a is the decompressed and decrypted instance of the corresponding ciphertext target file 103b.

In some embodiments, the system 100 can implement enhanced cryptographic techniques that incorporate password-based key derivation, per-message randomness, keyed transformations, and message authentication. For example, the encoder 107 may execute a key derivation function on a password and message randomness data including a salt and a nonce to generate a plurality of subkeys for controlling keyed transformations and authentication, where the key derivation function can be a memory-hard password-based key derivation function (e.g., scrypt, Argon2, PBKDF2, etc.) that incorporates the password, the salt, and the nonce to produce a master secret of a predetermined length. The encoder 107 can derive the plurality of subkeys from the master secret by applying a key derivation function or a pseudorandom function to the master secret with domain-specific labels that distinguish different subkey purposes, such that the plurality of subkeys include a first subkey for controlling keyed permutations applied to symbol-to-interval mappings within cumulative frequency tables, a second subkey for generating keyed residue shifts applied to remainder values during range asymmetric numeral system encoding, a third subkey for initializing adaptive frequency counts in entropy models, and a fourth subkey for computing message authentication codes to verify the integrity and authenticity of the encoded file. In some implementations, the encoder 107 can generate a unique salt value and a unique nonce value at the start of each encoding session by invoking a cryptographic random number generator, and the encoder 107 can incorporate the salt value and the nonce value into the key derivation function to produce subkeys that are distinct for each encoding session, thereby preventing patterns in encoded outputs from revealing information about the cleartext target file 103a or the password when the same cleartext target file 103a is encoded multiple times.

The encoder 107 can execute, during encoding of a cleartext target file 103a, a keyed permutation to symbol-to-interval mappings within one or more cumulative frequency tables based on one or more subkeys derived from the password and the message randomness data. For example, the encoder 107 can generate a context-specific seed for each cumulative frequency table by applying a cryptographic hash function to a combination of the first subkey, the nonce, and a context identifier that distinguishes different adaptive context models used during encoding. The encoder 107 can initialize a pseudorandom number generator with the context-specific seed and use the pseudorandom number generator to generate a sequence of pseudorandom values that determine a permutation order for symbols within the cumulative frequency table, where the permutation order determines how symbols are mapped to interval positions within the cumulative frequency table for a given context during encoding operations. In some implementations, the encoder 107 can apply a Fisher-Yates shuffle algorithm to reorder the symbols according to the sequence of pseudorandom values, thereby creating a keyed permutation that maps each symbol to a permuted position within the cumulative frequency table. The keyed permutation can alter the mapping between symbols and their interval positions without changing the frequency values associated with the symbols, such that the compression efficiency remains determined by the adaptive frequency counts while the internal structure of the cumulative frequency table becomes dependent on the first subkey and the nonce. In some implementations, the encoder 107 can generate a permutation map that associates each symbol and context pair with a permuted index and an inverse permutation map that facilitates retrieval of a symbol from a permuted index during subsequent decoding operations performed by the decoder 109.

The encoder 107 can perform, during encoding, a keyed residue shift on one or more remainder values in a range asymmetric numeral system using a second subkey derived from the password and the message randomness data. For example, the encoder 107 can initialize a keystream generator with the second subkey and the nonce to produce a sequence of pseudorandom offset values for each symbol occurrence during the encoding process. For each input byte to be encoded, the encoder 107 can determine a remainder value by computing the modulus of a current state value with respect to a frequency of the input byte as indicated by the frequency table, and the encoder 107 can obtain a pseudorandom offset value from the keystream generator and calculate a shifted remainder by adding the pseudorandom offset value to the remainder value and taking the result modulo the frequency of the input byte. In some implementations, the shifted remainder can be used in place of the remainder value when computing a new state value according to a range asymmetric numeral system encoding formula, such that the new state value becomes a function of the quotient, a scaling factor, a cumulative frequency, and the shifted remainder. The keyed residue shift can introduce key-dependent randomization into the state evolution without altering the probability distribution of symbols or affecting the compression ratio achieved by the range asymmetric numeral system encoding. In some implementations, the encoder 107 can maintain synchronization between the keystream generator and the encoding operations to ensure that each symbol occurrence uses a unique pseudorandom offset value derived from the second subkey and the nonce.

The encoder 107 can execute an entropy model on the cleartext target file 103a with adaptive frequency counts based on a third subkey derived from the password and the message randomness data. For example, the encoder 107 can initialize a plurality of context-specific frequency tables, where each frequency table corresponds to a different adaptive context model and tracks occurrence counts for symbols observed within a particular context. The encoder 107 can use the third subkey to initialize starting frequency counts for each symbol in each context-specific frequency table, such that instead of beginning with uniform initial counts, the frequency tables begin with non-uniform initial counts derived from the third subkey. In some implementations, the encoder 107 can generate the initial counts by applying a pseudorandom function to the third subkey and a context identifier to produce a sequence of pseudorandom values that determine the initial frequency count for each symbol. The encoder 107 can update the frequency counts adaptively during the encoding process by incrementing the frequency count for a symbol each time the symbol is encoded within a corresponding context, where the adaptive frequency counts allow the entropy model to learn patterns in the cleartext target file 103a and assign shorter codes to more frequently occurring symbols. In some implementations, the encoder 107 can implement the adaptive frequency counts using a Fenwick tree data structure or a similar data structure that allows efficient incremental updates and cumulative frequency queries.

The encoder 107 can encode the plurality of input bytes using the keyed transformations and the frequency table according to an adaptive context model to produce variable bit-length codes. For example, the encoder 107 can sequentially process each input byte from the cleartext target file 103a and determine a current context based on one or more previously encoded input bytes. The encoder 107 can select a context-specific frequency table corresponding to the current context and apply the keyed permutation to determine a permuted interval position for the input byte within the cumulative frequency table, where the encoder 107 computes a quotient and a remainder by dividing a current state value by a frequency of the input byte as indicated by the frequency table, and then applies the keyed residue shift to the remainder to produce a shifted remainder. In some implementations, the encoder 107 can calculate a new state value using a range asymmetric numeral system encoding formula that combines the quotient, a scaling factor, a cumulative frequency determined from the permuted interval position, and the shifted remainder. The encoder 107 can determine whether the new state value satisfies a renormalization threshold, and when the new state value meets or exceeds the renormalization threshold, the encoder 107 can emit one or more output bits by extracting low-order bits from the new state value and appending the low-order bits to an encoded output buffer. In some implementations, the encoder 107 can update the new state value by dividing the new state value by a base value after emitting the output bits, and then repeat the renormalization check until the new state value falls below the renormalization threshold. The encoder 107 can adaptively update the frequency count for the input byte in the context-specific frequency table after encoding the input byte, thereby modifying the frequency table to reflect the occurrence of the input byte and improve compression performance for subsequent input bytes with similar patterns.

The encoder 107 can mask an encoded output and a final state with a keyed keystream, thereby generating a masked payload for the ciphertext target file 103b. For example, the encoder 107 can initialize a keystream generator with a masking subkey derived from the plurality of subkeys and the nonce to produce a pseudorandom keystream that is used to mask the encoded output and the final state value. The encoder 107 can apply a bitwise exclusive-or operation between each byte of the encoded output buffer and a corresponding byte from the keystream to produce masked output bytes, and the encoder 107 can similarly apply a bitwise exclusive-or operation between the final state value and a portion of the keystream to produce a masked final state value. In some implementations, masking the encoded output and the final state with the keyed keystream can prevent structural leakage by obscuring patterns in the encoded data that might otherwise reveal information about the cleartext target file 103a or the frequency distribution used during encoding. The masked payload can include the masked output bytes and the masked final state value, along with metadata indicating lengths or offsets of various portions of the masked payload.

The encoder 107 can generate a message authentication code computed over the salt, nonce, the masked payload, and the final state using a fourth subkey derived from the password and the message randomness data. For example, the encoder 107 can execute a hash-based message authentication code algorithm (e.g., HMAC-SHA256, HMAC-SHA512, etc.) with the fourth subkey as a key input and a concatenation of the salt, the nonce, the masked payload, and metadata as a message input. The message authentication code can provide cryptographic integrity and authenticity verification for the ciphertext target file 103b by allowing a recipient to verify that the ciphertext target file 103b has not been tampered with and that the ciphertext target file 103b was produced using the correct password. In some implementations, the encoder 107 can compute the message authentication code by applying a cryptographic hash function to the fourth subkey and the message input according to the hash-based message authentication code specification. The message authentication code can have a fixed length (e.g., 32 bytes for HMAC-SHA 256, etc.) and can be appended to the ciphertext target file 103b along with the salt, the nonce, and the masked payload. In some implementations, the encoder 107 can store the message authentication code in a header or footer section of the ciphertext target file 103b to allow the decoder 109 to verify the message authentication code before attempting to decode the masked payload.

The encoder 107 can generate the ciphertext target file 103b comprising the masked payload and the authentication data. For example, the encoder 107 can assemble the ciphertext target file 103b by concatenating a version identifier, the salt, the nonce, the masked payload, and the message authentication code in a predetermined order. The version identifier can indicate a format version or encoding scheme used to produce the ciphertext target file 103b, allowing the decoder 109 to determine the appropriate decoding operations to apply. In some implementations, the encoder 107 can write the ciphertext target file 103b to a storage medium (e.g., a hard disk drive, a solid-state drive, etc.) or transmit the ciphertext target file 103b to the second computer 102b via the one or more networks 105. The ciphertext target file 103b can include metadata indicating the length of the salt, the nonce, the masked payload, and the message authentication code, allowing the decoder 109 to parse the ciphertext target file 103b and extract each component.

The decoder 109 can obtain the ciphertext target file 103b comprising a masked payload and authentication data, a password, and message randomness data including a salt and a nonce. For example, the decoder 109 can receive the ciphertext target file 103b from a storage medium where the ciphertext target file 103b was previously written by the encoder 107, or the decoder 109 can receive the ciphertext target file 103b via the one or more networks 105 from the second computer 102b. The ciphertext target file 103b can include a version identifier indicating a format version or encoding scheme used during encoding, followed by the salt, the nonce, the masked payload containing masked output bytes and a masked final state value, and a message authentication code computed over these components using a fourth subkey derived from the password. In some implementations, the decoder 109 can parse the ciphertext target file 103b to extract each component by reading predetermined fields or by interpreting length indicators embedded within the ciphertext target file 103b. The decoder 109 can obtain the password from a user via a user interface, retrieve the password from a secure credential store, or receive the password from another computing device via a secure communication channel. In some implementations, the salt can include a cryptographically random value that was generated during encoding to ensure per-message uniqueness of the derived subkeys, and the nonce can include a unique value generated during encoding to initialize keyed transformations and prevent replay attacks.

The decoder 109 can execute a key derivation function on the password and the message randomness data to generate a plurality of subkeys for controlling keyed transformations and authentication. For example, the decoder 109 can execute a memory-hard key derivation function (e.g., scrypt, Argon2, PBKDF2, etc.) that incorporates the password, the salt extracted from the ciphertext target file 103b, and the nonce to produce a master secret of a predetermined length. The key derivation function can include configurable parameters (e.g., memory cost, time cost, parallelism factor, etc.) that control the computational difficulty of deriving the master secret from the password, where these parameters are selected to provide sufficient resistance against brute-force password guessing attacks. In some implementations, the decoder 109 can derive the plurality of subkeys from the master secret by applying a key derivation function or a pseudorandom function to the master secret with domain-specific labels that distinguish different subkey purposes. The plurality of subkeys can include a first subkey for controlling keyed permutations applied to symbol-to-interval mappings within cumulative frequency tables, a second subkey for generating keyed residue shifts applied to remainder values during range asymmetric numeral system decoding, a third subkey for initializing adaptive frequency counts in entropy models, and a fourth subkey for computing message authentication codes to verify the integrity and authenticity of the ciphertext target file 103b. In some implementations, the decoder 109 can generate each subkey by concatenating the master secret with a unique label and applying a cryptographic hash function to produce a subkey of a required length.

The decoder 109 can verify the authentication data by computing a message authentication code over the salt, nonce, masked payload, and an encoded final state, and comparing the computed message authentication code to the authentication data, proceeding only upon successful verification. For example, the decoder 109 can execute a hash-based message authentication code algorithm with the fourth subkey as a key input and a concatenation of the salt, the nonce, the masked payload, and metadata as a message input to produce a computed message authentication code. The decoder 109 can extract the authentication data from the ciphertext target file 103b, where the authentication data includes a message authentication code that was generated during encoding by the encoder 107. In some implementations, the decoder 109 can compare the computed message authentication code to the authentication data by performing a byte-by-byte comparison or by executing a constant-time comparison function that prevents timing-based attacks. When the computed message authentication code matches the authentication data, the decoder 109 can determine that the ciphertext target file 103b has not been tampered with and that the password provided is correct, thereby proceeding to subsequent decoding operations. In some implementations, when the computed message authentication code does not match the authentication data, the decoder 109 can determine that the ciphertext target file 103b has been modified, corrupted, or that an incorrect password was provided, and the decoder 109 can abort the decoding process by terminating and generating an error message that is displayed to a user via a user interface.

The decoder 109 can unmask the masked payload and the encoded final state using a keyed keystream generated from the plurality of subkeys. For example, the decoder 109 can initialize a keystream generator with a masking subkey derived from the plurality of subkeys and the nonce extracted from the ciphertext target file 103b to produce a pseudorandom keystream. The masking subkey can be derived by applying a key derivation function or a cryptographic hash function to the master secret and a domain-specific label. In some implementations, the decoder 109 can apply a bitwise exclusive-or operation between each byte of the masked payload and a corresponding byte from the keystream to produce unmasked output bytes. The decoder 109 can apply a bitwise exclusive-or operation between the masked final state value and a portion of the keystream to produce an unmasked final state value, where the unmasked final state value represents a state value that was used during encoding to finalize the range asymmetric numeral system encoding process. In some implementations, the unmasked output bytes can include encoded data representing the cleartext target file 103a in compressed form with variable bit-length codes.

The decoder 109 can generate a frequency table having adaptive frequency counts based on a subkey, and apply a keyed permutation to symbol-to-interval mappings within one or more cumulative frequency tables for a context according to a subkey. For example, the decoder 109 can initialize a plurality of context-specific frequency tables corresponding to different adaptive context models used during decoding, where each frequency table tracks occurrence counts for symbols observed within a particular context determined by one or more previously decoded symbols. The decoder 109 can use the third subkey to initialize starting frequency counts for each symbol in each context-specific frequency table by applying a pseudorandom function to the third subkey and a context identifier to produce a sequence of pseudorandom values that determine the initial frequency count for each symbol. In some implementations, the decoder 109 can generate a context-specific seed for a cumulative frequency table by applying a cryptographic hash function to a combination of the first subkey, the nonce extracted from the ciphertext target file 103b, and a context identifier that distinguishes different adaptive context models. The decoder 109 can initialize a pseudorandom number generator with the context-specific seed and use the pseudorandom number generator to generate a sequence of pseudorandom values that determine a permutation order for symbols within the cumulative frequency table. In some implementations, the decoder 109 can apply a Fisher-Yates shuffle algorithm or another shuffling algorithm to reorder the symbols according to the sequence of pseudorandom values, thereby creating a keyed permutation that maps each symbol to a permuted position within the cumulative frequency table. The keyed permutation can alter the mapping between symbols and their interval positions within the cumulative frequency table without changing the frequency values associated with the symbols, such that the compression efficiency remains determined by the adaptive frequency counts while the internal structure of the cumulative frequency table becomes dependent on the first subkey and the nonce. In some implementations, the decoder 109 can generate a permutation map that associates each symbol and context pair with a permuted index and an inverse permutation map that allows retrieval of a symbol from a permuted index during decoding operations.

The decoder 109 can decode the unmasked payload using a range asymmetric numeral system decoder incorporating a keyed residue shift reversal on remainder values in accordance with a derived subkey and the frequency table having the adaptive frequency counts, thereby generating decoded bytes for the cleartext target file 103a. For example, the decoder 109 can initialize a state value with the unmasked final state value and an input buffer with the unmasked output bytes. The decoder 109 can sequentially decode each symbol by first determining a current context based on one or more previously decoded symbols, selecting a context-specific frequency table corresponding to the current context, and applying the inverse keyed permutation to determine which symbol corresponds to a current interval position within the cumulative frequency table.

In some implementations, the decoder 109 can determine whether the state value is less than a scaling factor, and when the state value is less than the scaling factor, the decoder 109 can read one or more bytes from the input buffer and incorporate the bytes into the state value by multiplying the state value by a base value and adding a byte value from the input buffer. The decoder 109 can continue reading bytes from the input buffer until the state value is greater than or equal to the scaling factor, thereby ensuring that the state value is large enough to decode a symbol according to the range asymmetric numeral system decoding formula. In some implementations, the decoder 109 can determine an interval position within the cumulative frequency table by computing a modulus of the state value with respect to the scaling factor, and then use the inverse permutation map to determine which symbol corresponds to the interval position. The decoder 109 can determine a frequency value and a cumulative frequency value for the decoded symbol from the context-specific frequency table, and then compute a quotient and a remainder by dividing the state value by the frequency value. In some implementations, the decoder 109 can initialize a keystream generator with the second subkey and the nonce to produce a sequence of pseudorandom offset values, where each offset value corresponds to a particular symbol occurrence during the decoding process.

The decoder 109 can obtain a pseudorandom offset value from the keystream generator and calculate a keyed residue shift reversal by subtracting the pseudorandom offset value from the remainder value and taking the result modulo the frequency value, thereby reversing the keyed residue shift that was applied during encoding by the encoder 107. In some implementations, the decoder 109 can compute a new state value using a range asymmetric numeral system decoding formula that combines the quotient, the frequency value, the reversed remainder value, and the cumulative frequency value. The decoder 109 can append the decoded symbol to an output buffer containing decoded bytes, and then adaptively update the frequency count for the decoded symbol in the context-specific frequency table by incrementing the frequency count to reflect the occurrence of the decoded symbol. In some implementations, the decoder 109 can repeat the decoding operations for subsequent symbols until an end-of-file (EOF) symbol is decoded, indicating that all input bytes have been decoded and the decoding process is complete. For instance, the decoder 109 or other component of the system 100 may implement an EOF symbol according to the entropy model to signal termination of encoding, which may include adding to or replacing one or more (or any) prior unit counting or length tracking mechanisms.

The decoder 109 can generate the cleartext target file 103a comprising the decoded bytes. For example, the decoder 109 can assemble the cleartext target file 103a by concatenating the decoded bytes stored in the output buffer after the decoding operations completed. The cleartext target file 103a can be written to a storage medium at a location specified by a user or by a configuration parameter, or the cleartext target file 103a can be transmitted to another computing device via the one or more networks 105. In some implementations, the decoder 109 can verify that the cleartext target file 103a matches the original cleartext target file 103a that was encoded by comparing a hash of the cleartext target file 103a to a hash of the original cleartext target file 103a.

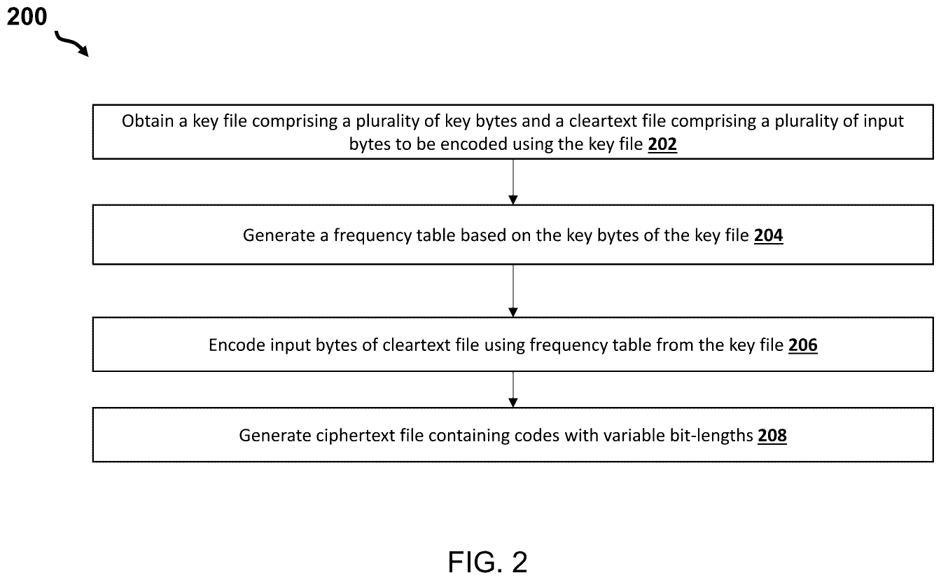

FIG. 2 is a flowchart of operations of a computer-implemented method 200 for encoding (e.g., jointly compressing and encrypting) cleartext input data of a cleartext data file or data stream, according to embodiments. For ease of description and understanding, the operations of the computer-implemented method 200 are described as being performed by a computer, though embodiments may be implemented using any type of computing device and/or may be implemented using multiple computing devices.

In operation 202, the computer obtains a key file comprising a plurality of key bytes and a cleartext file comprising a plurality of input bytes to be encoded using the key file. The computer selects from a memory the cleartext file to encode (e.g., digital text file of “The Great Gatsby”) and the key file (e.g., digital text file of “Hounds of Bakersfield”), which the computer uses to generate a frequency table for compression. For ease of description, in the example process 200, the computer receives a cleartext file of text (“abbc”) and uses a similar key file (“aaabbcd”).

In operation 204, the computer generates a frequency table based on the key bytes of the key file. For each key byte, the frequency table indicates a frequency of occurrence of the key byte within the cleartext file. The computer may parse or convert the data of the key file into a list of key bytes. The computer may count or determine the frequency of each key byte occurring in the key file to create the frequency table. The frequency table represents how often each key byte appears in the key file.

In some implementations, the computer generates a hash of the key file. The computer references this key hash as a unique identifier for the key file. The computer uses the key hash to randomize various pieces of information required or generated for the encoding process 200, such as operations for generating an alphabet, determining frequencies, and generating symbol indexes. Using the hash of the key file, the computer generates the alphabet and frequencies. For example, the alphabet might be (‘d’, ‘c’, ‘b’, ‘a’), and the frequencies might be (1, 1, 2, 3). The computer may also determine cumulative frequencies, which the computer calculates by adding up the frequencies for each position. For example, the cumulative frequencies might be [0, 1, 2, 4, 7]. The symbol indexes are created based on the alphabet. For example, the symbol indexes might be {‘d’: 0, ‘c’: 1, ‘b’: 2, ‘a’: 3}. The key hash of the key file (“aaabbcd”) is used to generate the following information based on the key file:
Key file: “aaabbcd”
Alphabet: [‘d’, ‘c’, ‘b’, ‘a’]
Frequencies: [1, 1, 2, 3]
Cumulative frequencies: [0, 1, 2, 4, 7]
Symbol indexes: {‘d’: 0, ‘c’: 1, ‘b’: 2, ‘a’: 3}

By using the key hash of the key file, the encoding process ensures that the same key file will always produce the same randomized information. This consistency is essential for both encoding and decoding, as the consistency allows the process 200 to be reversible. Additionally, the use of the hash adds a layer of security, as the exact hash value is required to generate the correct frequency table and other information during decoding (e.g., process 300).

In operation 206, the computer encodes the input bytes of the cleartext file using the frequency table from the key file. For each input byte, the computer generates a code having a bit-length based upon the frequency of occurrence of the input byte, as indicated by the frequency table. The computer generates or outputs a plurality of codes having variable bit-lengths for the input bytes.

In some implementations, when the encoding begins, the computer may set initial values for a state value (x) and unit counting value (unit_count). In an example, for a first character, x is set to 1, and unit_count is set to 0. The state value represents a running total or an accumulator that indicates a current state of the encoding process 200, where the state value is a counter that the computer updates with each step of the encoding process 200. For instance, each time the computer encodes an input byte or character, the computer updates the state value counter (e.g., x) based on the frequency of the recent input character. If the total state value for the input bytes or characters exceeds a certain threshold, the computer updates or adjusts the encoded output. In the context of the ANS algorithm, the state value helps manage the encoding process 200 by tracking the cumulative effect of encoding each input byte or character of the cleartext file. With the initial values set, the computer proceeds to encode the input data (e.g., input bytes, input characters) of the cleartext file, in which the computer sequentially encodes each input byte or character in the input file based on generated frequencies and cumulative frequencies of the key file and cleartext files.

The computer may parse or convert the input data of the cleartext file into a list of input bytes or input characters. The computer encodes the set of input bytes based on the frequencies of the input bytes and using the frequency table generated from the key file. For each input byte or input character, the computer determines the index in the symbol indexes; obtains the frequency (f) of the input character from the frequency table; and updates the value of x based on the frequency and the cumulative frequencies. If x exceeds a certain threshold for the input character, then the computer updates the encoded output and adjusts x for the character accordingly.

Continuing with the earlier example, the computer obtained (in operation 202) the cleartext file containing the text (“abbc”) and the key file containing the text (e.g., “aaabbcd”). The computer generated and employed the key hash of the key file to generate a frequency table for the key file and related information of the key file that is later used for encoding. For instance, the information for the key file generated by computer includes the Alphabet (‘d’, ‘c’, ‘b’, ‘a’), frequencies (1, 1, 2, 3), cumulative frequencies [0, 1, 2, 4, 7], and symbol indexes {‘d’: 0, ‘c’: 1, ‘b’: 2, ‘a’: 3} for the key file. The computer also initializes or sets the initial values for the satte value (x) and unit counter value (unit_count). For the first character, x is set to 1, and unit_count is set to 0.

The computer then proceeds to encode the input characters (“abbc”) in this example. For the first input character (“a”), the computer determines the index is 3 according to the symbol indexes, and the frequency (f) is 3 because the frequency at that index is 3. The computer then determines whether the state value (x) satisfies an output threshold. In this example, the output threshold is determined as base*f (e.g., 2*3=5). Because the state value (x=1) is not greater than or equal to the 5, the computer does not produce an encoded output yet and the computer proceeds. After encoding the first character, the computer updates the state value (x). In this example, the computer updates the state value using the formula (x=(x//f)*L+(x % f)+cumulative_frequencies[index]), where x is the state value, f is the frequency of the character, and L is a scaling factor (in this example, L=7). In this example, at the first character (“a”), the computer determines x=5 and thus updates the statue value accordingly. After encoding the first input character (“a”), x is 5, and unit_count is 1.

For the second input character (“b”), the computer determines the index is 2 according to the symbol indexes, and the frequency (f) is 2 because the frequency at that index is 2. In this example, the unit_count is unchanged because the state value is not 1. The computer then determines whether the state value (x) satisfies the output threshold. In this example, the output threshold is determined as base*f (e.g., 2*2=4). Because the current state value (x=5) is greater than 4, the computer generates and appends to the encoded output, using x % base (5% 2=1), such that the next encoded output is 1. The computer may update the state value (x) to x//base (5//2=2), such that x is less than the output threshold (2*2). The computer then updates the state value according to the state value formula, where (2//2)*7+(2% 2)+2=9 as the updated state value. After encoding the second input character, the total encoded output is 1, x is 9, and the unit_count remains 1.

For the third input character (“b”), the computer determines the index is 2 according to the symbol indexes, and the frequency (f) is 2 because the frequency at that index is 2. In this example, the unit_count is unchanged because the state value is not 1. The computer then determines whether the state value (x) satisfies the output threshold. In this example, the output threshold is determined as base*f (e.g., 2*2=4). Because the current state value (x=9) is greater than 4, the computer generates and appends to the encoded output using x % base (9% 2=1), such that the next appended output is 1. The computer then updates the current state value using x//base (9//2=4). Because the current state value (x=4) is equal to the threshold (2*2), the computer may again generate and append to the encoded output using x % base (4% 2=0), such that next appended output is 0. The computer again updates the current state value using x//base (4//2=2), which is less than the size threshold (2*2). The computer then updates the state value according to the state value formula, where (2//2)*7+(2% 2)+2=9 as the updated state value. After encoding the third input character, the encoded output is 110, x is 9, and the unit_count remains 1.

For the fourth input character (“c”), the computer determines the index is 1 according to the symbol indexes, and the frequency (f) is 1 because the frequency at that index is 1. In this example, the unit_count is unchanged because the state value is not 1. The computer then determines whether the state value (x) satisfies the output threshold. In this example, the output threshold is determined as base*f (e.g., 1*2=2). Because the current state value (x=9) is greater than 2, the computer generates and appends to the encoded output using x % base (9% 2=1), such that the next appended output is 1. The computer then updates the current state value using x//base (9//2=4). Because the current state value (x=4) is equal to the threshold (2*2), the computer may again generate and append to the encoded output using x % base (4% 2=0), such that next appended output is 0. The computer again updates the current state value using x//base (4//2=2). Because the current state value (x=2) is equal to the threshold (2*2), the computer may again generate and append to the encoded output using x % base (2% 2=0), such that next appended output is 0. The computer again updates the current state value using x//base (2//2=1), which is less than the size threshold (2*2). The computer then updates the state value according to the state value formula, where (2//2)*7+(2l% 2)+2=8 as the updated state value. After encoding the fourth input character, the encoded output is 110100, x is 8, and the unit_count remains 1.

In operation 208, the computer generates a ciphertext file for the cleartext file comprising the plurality of codes with variable bit-lengths. The computer may also generate output codes representing certain types of metadata or related information, such as the current state value, unit count, or byte-lengths for various portions of the encoded ciphertext code. Continuing with the earlier example, for instance, the computer may execute a VARINT operation on the state value (x) and the unit counter value (unit_count), to produce 0000100000000001, which is two bytes long. The computer may further generate a byte-length or bit-size indictor for portions of the encoded data. For instance, the computer may append 0010 to represent two bytes in length for the metadata information based on the VARINT. In this example, the computer would output a final encoded message for the ciphertext as metadata length (0010), encoded message (110100), and metadata (0000100000000001); or 0010 110100 0000100000000001.

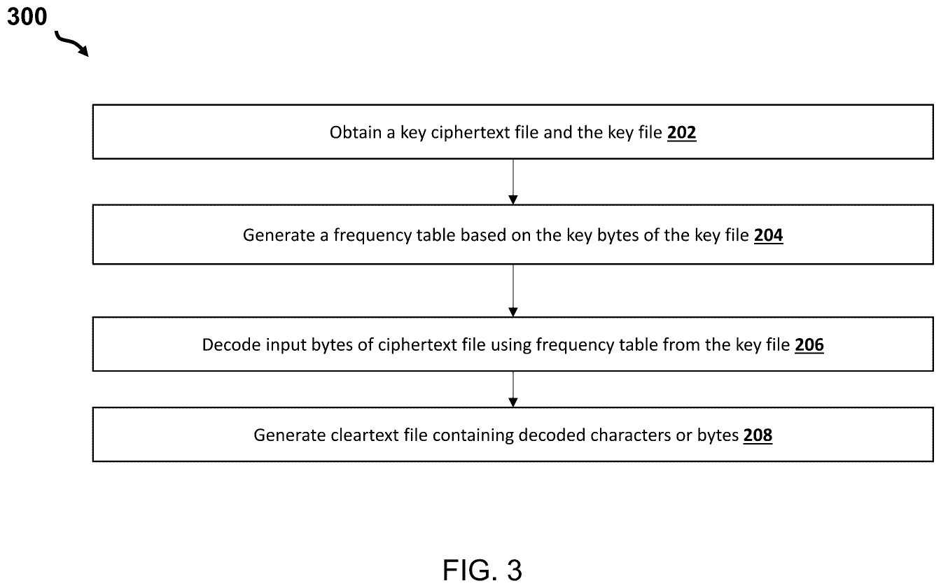

FIG. 3 is a flowchart of operations of a computer-implemented method 300 for decoding (e.g., jointly decompressing and decrypting) ciphertext input data of a ciphertext data file or data stream, according to embodiments. For ease of description and understanding, the operations of the computer-implemented method 300 are described as being performed by a computer, though embodiments may be implemented using any type of computing device and/or may be implemented using multiple computing devices.

In operation 301, a computer can begin the decoding process by receiving the ciphertext file and the key file. In an example, the computer can generate the hash of the key file to use as a randomizer, which is essential for generating the necessary information for decoding.

In operation 302, the computer generates a frequency table based upon the key bytes of the key file. The computer may generate the alphabet, frequencies, cumulative frequencies, and symbol indexes from the hash of the key file. In some examples, the alphabet can be (‘d’, ‘c’, ‘b’, ‘a’), the frequencies can be (1, 1, 2, 3), the cumulative frequencies can be [0, 1, 2, 4, 7], and the symbol indexes can be {‘d’: 0, ‘c’: 1, ‘b’: 2, ‘a’: 3}.

The computer can initialize the decoding process by setting initial values for x and unit_count. In an example, the computer can set x to the value extracted from the encoded message and unit_count to the corresponding value. In this example, the computer can use these initial values to prepare for decoding each character in the encoded message. In some examples, the computer can ensure that the initial values are correctly set to maintain the accuracy of the decoding process.

In operation 303, the computer decodes input bytes parsed from the ciphertext file using frequency table from the key file. The computer may decode each character in the encoded message sequentially. In an example, the computer can determine the index of each character in the symbol indexes and use the corresponding frequency to update x. In this example, the computer can use the formula (x=(x-cumulative_frequencies[index]) \times f+(x % L)) to update x for each character. In some examples, the computer can append the decoded character to the output message and continue this process until all characters are decoded. In at least some examples, the computer can ensure that the decoded message is accurate by verifying the consistency of the updated x values.

In operation 304, the computer generates or recovers the cleartext file containing decoded characters or bytes. The computer can finalize the decoding process by combining the decoded characters to form the original message or cleartext file. Optionally, the computer can verify the integrity of the decoded message by comparing the cleartext file data against the expected output. The computer can ensure that the decoded message matches the original message encoded using the same key file. The computer may store the decoded message in a secure location or transmit for display at the user interface of an end-user. In some implementations, the computer can log the decoding process for auditing and verification purposes.

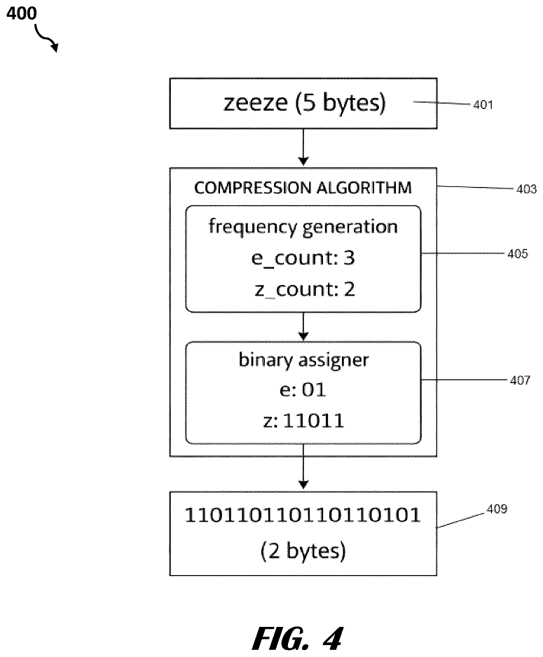

FIG. 4 depicts dataflow amongst components of a system 400 performing operations of a process for jointly compressing and encrypting input data using frequency-based variable-length code assignment, according to embodiments. The system 400 includes input data 401 representing data to be compressed and encrypted. A compression engine 403 receives the input data 401 and performs compression operations. Within the compression engine 403, a frequency engine 405 analyzes the input data 401 to determine frequency characteristics based on a key file. An assignment engine 407 assigns variable-length codes to data elements based on the frequencies determined by the frequency engine 405, where more frequently occurring data elements receive shorter codes and less frequently occurring data elements receive longer codes. The system 400 generates output data 409 representing the compressed and encrypted result, which contains the variable-length codes produced by the assignment engine 407. As illustrated in the example of FIG. 4, an input string of five bytes may be compressed to an output of two bytes through the frequency-based variable-length encoding process implemented by the compression engine 403.

The input data 401 may include text files, word-processing documents, media files such as audio or video, database records, or any other form of computing data stored in a machine-readable storage medium. The system 400 processes the input data 401 through a compression engine 403 that executes operations for jointly compressing and encrypting the data. The compression engine 403 implements an Asymmetric Numeral System (ANS) technique to leverage statistical properties of symbols by assigning codes of varying lengths based on frequency characteristics derived from a key file. The compression engine 403 includes a frequency engine 405 that analyzes byte frequencies within the key file to generate a frequency table indicating occurrence rates for each key byte. The frequency engine 405 parses the key file into a list of key bytes and determines how often each key byte appears, thereby creating the frequency table that represents the distribution of data elements within the key file. In some implementations, the frequency engine 405 can generate a hash of the key file and use the hash to randomize an alphabet, frequencies, cumulative frequencies, and symbol indexes for the encoding process. For example, the frequency engine 405 may generate an alphabet such as (‘d’, ‘c’, ‘b’, ‘a’), frequencies such as (1, 1, 2, 3), and cumulative frequencies such as [0, 1, 2, 4, 7], where the hash of the key file serves as a seed for a pseudorandom number generator that determines the order in which symbols are arranged within the alphabet. In some implementations, the frequency engine 405 can store the frequency table for repeated use during encoding operations. For example, the frequency engine 405 may store the frequency table in a memory accessible to the compression engine 403 such that subsequent encoding operations for the same key file can access the stored frequency table without regenerating the frequency data.

The assignment engine 407 encodes the input bytes of the input data 401 using the frequency table produced by the frequency engine 405. The assignment engine 407 generates variable-length codes for each input byte, where more frequently occurring bytes receive shorter codes and less frequently occurring bytes receive longer codes. For example, an input byte appearing with high frequency may be encoded as a four-bit code, while a rarely occurring input byte may be encoded as a six-bit code. In some implementations, the assignment engine 407 can initialize a state value and a unit counting value at the start of the encoding process. For example, the assignment engine 407 may set the state value to an initial value such as 1 and set the unit counting value to 0 before processing the first input byte. The state value represents a running total that indicates a current state of the encoding process, and the assignment engine 407 updates the state value with each encoded input byte based on the frequency of that input byte as indicated by the frequency table. In some implementations, the assignment engine 407 can determine whether the state value satisfies an output threshold for a given input byte. For example, the assignment engine 407 may calculate the output threshold as the product of a base value and the frequency of the input byte, and when the state value meets or exceeds the output threshold, the assignment engine 407 generates and appends encoded output bits to the output data 409 and updates the state value by dividing the state value by the base value. In some implementations, the assignment engine 407 can apply a residue shift operation during encoding to introduce key-dependent randomization into the encoding process. For example, the assignment engine 407 may generate a pseudorandom offset value based on a subkey derived from the key file and a nonce, and then compute a shifted remainder by adding the offset value to a remainder value modulo the frequency of the input byte, thereby altering the internal logic of the ANS encoding without affecting the probability distribution or the compression efficiency.

Upon completing the encoding operations, the system 400 produces output data 409 representing the input data 401 in compressed and encrypted form. The output data 409 comprises a plurality of codes having variable bit-lengths corresponding to the input bytes, where the encoded data portions reflect the frequency-based assignments determined by the assignment engine 407. In some implementations, the output data 409 can include metadata indicating the current state value, the unit counting value, and byte-length indicators for portions of the encoded data. For example, the assignment engine 407 may execute a variable-length integer encoding operation on the state value and the unit counting value to produce a metadata portion that is appended to the encoded message along with a byte-length indicator that specifies the size of the metadata portion. As illustrated in FIG. 4, the compression and encryption process may achieve substantial data reduction, such as converting a five-byte input string into a two-byte output, thereby demonstrating the compression efficiency of the frequency-based variable-length encoding technique implemented by the system 400.

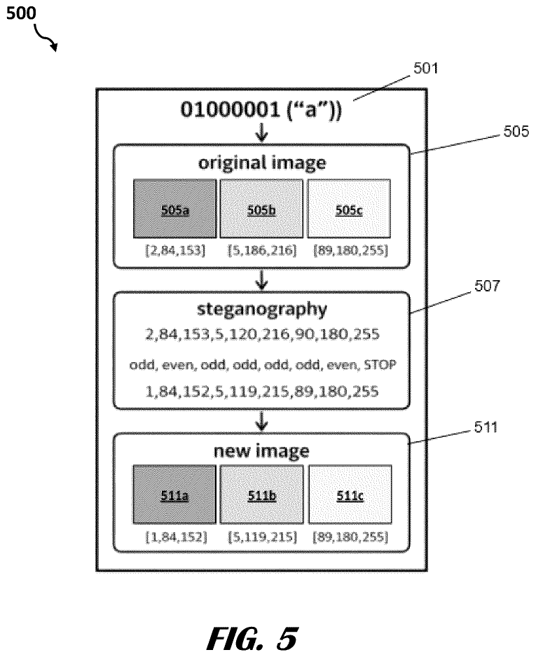

FIG. 5 shows dataflow amongst components of a system 500 for compressing and encrypting data using variable-length compression operations and steganography, according to embodiments. The computer may receive an image file and manipulate the image data (e.g., pixel color data) to imperceptibly encode a ciphertext file into the image data.

As shown in FIG. 5, the computer executes the steganography engine 507, which includes software functions and routines to edit the color values (sometimes referred to as “RGB” values) of the original pixel data 505 of the pixels within the original image data 503 of an image file. The steganography engine 507 may edit the RGB color values of the original pixel data 505 to either odd or even to represent ‘1’ or ‘0 ’ in the portion of the original image data 503. A typical encryption algorithm (e.g., AES-256) may use steganography to store one byte per three pixels. The embodiments described herein may improve upon the typical compression, such that the new image data 509 contains one byte for every one or two pixels (e.g., 1.69 pixels). A standard 1920*1080 pixel in a high-definition image may contain 1.23 MB of data compressed and encrypted as described herein.

The system 500 receives input data 501 representing cleartext information to be encoded and concealed within an image file. The input data 501 may include any form of computing data, such as text files, compressed encrypted files generated by the encoder 107, or binary data streams. In some implementations, the input data 501 can represent the ciphertext target file 103b produced by the encoder 107 of the compression engine 106, such that the input data 501 includes variable-length codes corresponding to encoded input bytes of a cleartext target file 103a. For example, the input data 501 may include a binary sequence generated by the encoder 107 where each code bit-length is determined by the frequency of occurrence of a corresponding input byte as indicated by a frequency table derived from the key file 104. In some implementations, the input data 501 can include metadata associated with the ciphertext target file 103b, such as a state value, a unit counting value, or byte-length indicators. For example, the input data 501 may include a metadata portion appended to an encoded message, where the metadata portion indicates a final state value and a final unit counting value generated during the encoding operations performed by the encoder 107. The input data 501 may be parsed into a binary representation by the steganography engine 507 prior to embedding within the original image data 503. In some implementations, the input data 501 can be obtained from a local storage memory of the first computer 102a, received from the second computer 102b via the one or more networks 105, or retrieved from a database hosted at a remote computing device. For example, the first computer 102a may retrieve the input data 501 from a preconfigured non-transitory storage location accessible to the first computer 102a and provide the input data 501 to the steganography engine 507 for processing.

The system 500 obtains original image data 503 comprising a digital image file that serves as a carrier medium for embedding the input data 501. The original image data 503 includes original image pixels 505a-505n arranged in a two-dimensional array, where each original image pixel contains RGB color values representing the visual appearance of the image at a corresponding spatial location within the digital image file. In some implementations, the original image data 503 can include a raster image format in which pixel data are stored as a bitmap array. For example, the original image data 503 may include a bitmap image file format such as PNG, JPEG, BMP, or TIFF, among others, where each original image pixel 505a-505n contains three color channel values representing red, green, and blue intensity levels. In some implementations, the original image data 503 can include metadata associated with the digital image file, such as image dimensions, color space information, or pixel resolution parameters. For example, the original image data 503 may include metadata indicating that the image has dimensions of 1920 by 1080 pixels and uses an RGB color space with 8-bit color depth per channel, such that each original image pixel 505a-505n contains three 8-bit values ranging from 0 to 255. The original image data 503 may be obtained from a local storage memory of the first computer 102a, received from the second computer 102b via the one or more networks 105, or retrieved from a database hosted at a remote computing device. In some implementations, the steganography engine 507 can select a subset of the original image pixels 505a-505n for modification based on the bit-length of the input data 501 to be embedded. For example, the steganography engine 507 may determine a number of pixels required to encode the input data 501 by dividing the total bit-length of the input data 501 by a number of bits to be encoded per pixel, where each original image pixel may encode one or more bits by adjusting one or more of its RGB color channel values.

The steganography engine 507 processes the input data 501 and the original image data 503 to generate new image data 509 by imperceptibly modifying pixel color values to encode binary information. The steganography engine 507 parses the input data 501 into a binary representation by extracting individual bits from the input data 501 in sequential order, where each bit corresponds to a binary value of either ‘0’ or ‘1’. The steganography engine 507 sequentially encodes each bit by adjusting RGB color channel values of the original image pixels 505a-505n to odd values or even values, where odd values represent binary ‘1’ and even values represent binary ‘0’. In some implementations, the steganography engine 507 can modify a single RGB color channel value for each bit to be encoded. For example, the steganography engine 507 may select the red channel value of a first original image pixel 505a, determine whether the red channel value is odd or even, and adjust the red channel value by adding or subtracting one unit to match the required parity for encoding a corresponding bit from the input data 501, such that an original red channel value of 84 may be adjusted to 85 to encode a binary ‘1’ or adjusted to 84 (unchanged) to encode a binary ‘0’. In some implementations, the steganography engine 507 can distribute encoded bits across multiple RGB color channels of a single original image pixel. For example, the steganography engine 507 may encode three bits of the input data 501 within a single original image pixel 505a by adjusting the red channel value to encode a first bit, the green channel value to encode a second bit, and the blue channel value to encode a third bit, thereby increasing the data capacity of the steganographic embedding process.

The new image data 509 includes new image pixels 511a-511n containing modified RGB values that encode the input data 501 while maintaining visual similarity to the original image data 503. In some implementations, the system 500 can achieve improved data capacity compared to conventional steganographic methods by leveraging compression operations performed prior to embedding. For example, the new image data 509 may contain one byte of encoded data per approximately 1.69 pixels, representing a substantial improvement over typical steganographic techniques that store one byte per three pixels. In some implementations, a high-definition image with dimensions of 1920 by 1080 pixels may contain up to 1.23 MB of compressed and encrypted data embedded within imperceptible modifications to RGB color values. The steganography engine 507 applies minimal adjustments to RGB values of the original image pixels 505a-505n, where each modified value in the new image pixels 511a-511n may differ by at most one unit from a corresponding original value. In some implementations, the steganography engine 507 can adjust an RGB color channel value by adding one unit when the original value is even and the bit to be encoded is a binary ‘1’, or by subtracting one unit when the original value is odd and the bit to be encoded is a binary '0′, thereby ensuring that each new image pixel 511a-511n contains a parity-adjusted color channel value that encodes a corresponding bit from the input data 501. For example, the steganography engine 507 may receive an original image pixel 505a having an original red channel value of 84, determine that a first bit of the input data 501 is a binary ‘1’, and generate a new image pixel 511a having a new red channel value of 85 by adding one unit to the original red channel value, such that the odd parity of the new red channel value represents the binary ‘1’ according to the encoding scheme. The new image data 509 appears visually identical or nearly identical to the original image data 503 while concealing the presence of the encoded input data 501, such that a human observer viewing the new image data 509 may not detect the modifications to the RGB color channel values of the new image pixels 511a-511n.

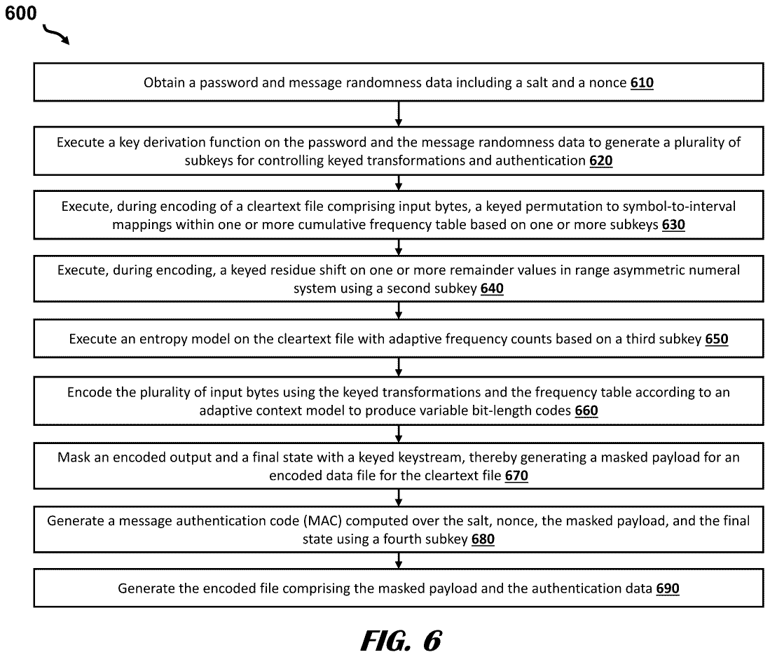

FIG. 6 shows operations of a computer-implemented method 600 for compressing and encrypting input data using authenticating data, according to embodiments. The method 600 includes operations for obtaining a password and per-message randomness data including a salt and a nonce, deriving cryptographic subkeys from the password through a key derivation function, applying keyed transformations to symbol-to-interval mappings within cumulative frequency tables during encoding, performing keyed residue shifts on remainder values in a range asymmetric numeral system (rANS) encoding process, executing an entropy model with adaptive frequency counts, encoding input bytes using the keyed transformations according to an adaptive context model to produce variable bit-length codes, masking an encoded output and a final state value with a keyed keystream, generating a message authentication code computed over the salt, nonce, masked payload, and final state value, and generating an encoded file comprising the masked payload and authentication data. For ease of description and understanding, the operations of the computer-implemented method 600 are described as being performed by a computer, though embodiments may be implemented using any type of computing device and/or may be implemented using multiple computing devices.

In some implementations, the method 600 can provide cryptographic protection against unauthorized decryption by requiring possession of the correct password and by incorporating per-message randomness to ensure that encoding the same cleartext file with the same password produces different encoded outputs across different encoding sessions. For example, the method 600 may generate a unique salt value and a unique nonce value at the start of each encoding session by invoking a cryptographic random number generator, and the method 600 may incorporate the salt value and the nonce value into the key derivation function to produce subkeys that are distinct for each encoding session, thereby preventing patterns in encoded outputs from revealing information about the cleartext file or the password when the same cleartext file is encoded multiple times.

In some implementations, the method 600 can apply keyed permutations to reorder symbols within cumulative frequency tables without altering frequency values, such that the compression efficiency remains determined by the adaptive frequency counts while the internal structure of the cumulative frequency tables becomes dependent on a subkey derived from the password and the nonce. For example, the method 600 may generate a context-specific seed by applying a cryptographic hash function to a first subkey, the nonce, and a context identifier, and the method 600 may initialize a pseudorandom number generator with the context-specific seed to produce a permutation order for symbols, where the permutation order determines how symbols are mapped to interval positions within a cumulative frequency table for a given context during encoding operations.

At operation 610, the computer obtains input data, including a password and message randomness data including a salt and a nonce. For example, the computer can receive the password from a user via a user interface or retrieve the password from a secure credential store accessible to the computer. In examples, the message randomness data can include cryptographically random values generated for a particular encoding session to ensure that encoding the same cleartext file with the same password produces different encoded outputs across different sessions. The salt can include a random value of a predetermined length (e.g., 16 bytes, 32 bytes, etc.) generated by a cryptographic random number generator. The nonce can include a unique value that the computer uses to initialize keyed transformations and prevent replay attacks. In some examples, the computer can generate the salt and the nonce at the start of the encoding process and store the salt and the nonce in the encoded file for use during subsequent decoding operations. For instance, the computer may receive a password “MySecurePassword123” from a user interface, generate a 32-byte salt value using a cryptographic random number generator, and generate a 16-byte nonce value to uniquely identify the current encoding session. The computer stores these values in memory for use in subsequent operations.

At operation 620, the computer executes a key derivation function on the password and the message randomness data to generate a plurality of subkeys for controlling keyed transformations and authentication. For example, the computer can execute a memory-hard key derivation function (e.g., scrypt, Argon2, etc.) that incorporates the password, the salt, and the nonce to produce a master secret of a predetermined length or cryptographic strength. In examples, the key derivation function can include configurable parameters (e.g., memory cost, time cost, parallelism factor, etc.) that control the computational difficulty of deriving the master secret from the password. The computer can derive the plurality of subkeys from the master secret by applying a key derivation function or a pseudorandom function to the master secret with domain-specific labels. In some examples, the plurality of subkeys can include a first subkey for controlling keyed permutations, a second subkey for generating keyed residue shifts, a third subkey for initializing adaptive frequency counts, and a fourth subkey for computing message authentication codes. The computer can generate each subkey by concatenating the master secret with a unique label (e.g., “permutation”, “residue”, “model”, “auth”, etc.) and applying a cryptographic hash function to produce a subkey of a required length. Continuing with the earlier example where the password is “MySecurePassword123” and the computer generated a 32-byte salt and 16-byte nonce, the computer may execute the scrypt key derivation function with a memory cost parameter of 16384, a time cost parameter of 8, and a parallelism factor of 1 to produce a 64-byte master secret. The computer then derives the first subkey by concatenating the master secret with the label “permutation” and applying SHA-256 to generate a 32-byte subkey for controlling keyed permutations. Similarly, the computer generates the second subkey by concatenating the master secret with “residue” and applying SHA-256, the third subkey by using the label “model”, and the fourth subkey by using the label “auth”. After these operations, the computer has generated four distinct 32-byte subkeys, each serving a different cryptographic purpose in the encoding process.

At operation 630, the computer executes, during encoding of a cleartext file comprising input bytes, a keyed permutation to symbol-to-interval mappings within one or more cumulative frequency tables based on one or more subkeys. For example, the computer can generate a context-specific seed for each cumulative frequency table by applying a cryptographic hash function to a combination of the first subkey, the nonce, and a context identifier that distinguishes different adaptive context models used during encoding. In examples, the computer can initialize a pseudorandom number generator with the context-specific seed and use the pseudorandom number generator to generate a sequence of pseudorandom values that determine a permutation order for symbols within the cumulative frequency table. The computer can apply a Fisher-Yates shuffle algorithm to reorder the symbols according to the sequence of pseudorandom values, thereby creating a keyed permutation that maps each symbol to a permuted position within the cumulative frequency table. In some examples, the keyed permutation can alter the mapping between symbols and their interval positions without changing the frequency values associated with the symbols, such that the compression efficiency remains determined by the adaptive frequency counts while the internal structure of the cumulative frequency table becomes dependent on the first subkey and the nonce. The computer can generate a permutation map that associates each symbol and context pair with a permuted index and an inverse permutation map that allows retrieval of a symbol from a permuted index during decoding operations. Continuing with the earlier example, assume the computer is encoding a cleartext file and encounters a context identified as “context_0” (representing the initial context). The computer generates a context-specific seed by applying SHA-256 to a concatenation of the first subkey, the nonce, and the context identifier “context_0”, producing a 32-byte seed value. The computer initializes a SplitMix 64 pseudorandom number generator with this seed. Suppose the alphabet contains 256 byte symbols plus one end-of-file symbol, for a total of 257 symbols. The computer uses the pseudorandom number generator to produce a sequence of random values and applies a Fisher-Yates shuffle to reorder the symbols. For instance, the original ordering might have symbol ‘A’ (byte value 65) at position 65 in the cumulative frequency table, but after the keyed permutation, symbol ‘A’ may be mapped to position 142. The computer generates a permutation map that records this mapping: permutation_map\[“context_0”\]\[65\]=142. The computer also generates an inverse permutation map: inverse_permutation_map\[“context_0”\]\[142\]=65. The frequency values remain unchanged; if symbol ‘A’ had a frequency of 5, it still has a frequency of 5, but its position in the cumulative frequency table has been permuted. This keyed permutation ensures that the internal structure of the cumulative frequency table is dependent on the password-derived subkey and the nonce, making it infeasible for an attacker without the correct password to reconstruct the correct symbol-to-interval mappings.

At operation 640, the computer performs, during encoding, a keyed residue shift on one or more remainder values in a range asymmetric numeral system using a second subkey. For example, the computer can initialize a keystream generator with the second subkey and the nonce to produce a sequence of pseudorandom offset values for each symbol occurrence during the encoding process. In examples, for each input byte to be encoded, the computer can determine a remainder value by computing the modulus of a current state value with respect to a frequency of the input byte as indicated by a frequency table. The computer can obtain a pseudorandom offset value from the keystream generator and calculate a shifted remainder by adding the pseudorandom offset value to the remainder value and taking the result modulo the frequency of the input byte. In some examples, the shifted remainder can be used in place of the remainder value when computing a new state value according to a range asymmetric numeral system encoding formula, such that the new state value becomes a function of the quotient, a scaling factor, a cumulative frequency, and the shifted remainder. The keyed residue shift can introduce key-dependent randomization into the state evolution without altering the probability distribution of symbols or affecting the compression ratio achieved by the range asymmetric numeral system encoding. In examples, the computer can maintain synchronization between the keystream generator and the encoding operations to ensure that each symbol occurrence uses a unique pseudorandom offset value derived from the second subkey and the nonce. Continuing with the earlier example, assume the computer is encoding the first input byte ‘A’ (byte value 65) from the cleartext file. The computer retrieves the frequency of symbol ‘A’ from the context-specific frequency table for “context_0” and determines that the frequency is 5. Assume the current state value is 47. The computer computes the remainder value by calculating 47 modulo 5, which equals 2. The computer initializes a keystream generator with the second subkey and the nonce, and retrieves the first pseudorandom offset value from the keystream, which might be 3. The computer calculates the shifted remainder by adding the offset value to the remainder value and taking the result modulo the frequency: (2+3) modulo 5 equals 0. The computer then proceeds to compute the new state value using the range asymmetric numeral system encoding formula. The quotient is 47 divided by 5 (integer division), which equals 9. Assume the scaling factor L is 257 (the total sum of frequencies in the frequency table) and the cumulative frequency for symbol ‘A’ (at its permuted position) is 20. The computer calculates the new state value as: new_state=(9*257)+20+0=2313+20+0=2333. Without the keyed residue shift, the new state value would have been 2313+20+2=2335. The keyed residue shift alters the state value by 2 in this example, introducing key-dependent randomization. The computer continues encoding subsequent input bytes, retrieving a new pseudorandom offset value from the keystream for each symbol occurrence, ensuring that each symbol's encoding is influenced by the password-derived second subkey.

At operation 650, the computer executes an entropy model on the cleartext file with adaptive frequency counts based on a third subkey. For example, the computer can initialize a plurality of context-specific frequency tables, where each frequency table corresponds to a different adaptive context model and tracks occurrence counts for symbols (e.g., byte values, etc.) observed within a particular context. In examples, the computer can use the third subkey to initialize starting frequency counts for each symbol in each context-specific frequency table, such that instead of beginning with uniform initial counts (e.g., one occurrence per symbol, etc.), the frequency tables begin with non-uniform initial counts derived from the third subkey. The computer can generate the initial counts by applying a pseudorandom function to the third subkey and a context identifier to produce a sequence of pseudorandom values that determine the initial frequency count for each symbol. In some examples, the computer can update the frequency counts adaptively during the encoding process by incrementing the frequency count for a symbol each time the symbol is encoded within a corresponding context. The adaptive frequency counts can allow the entropy model to learn patterns in the cleartext file and assign shorter codes to more frequently occurring symbols, thereby achieving improved compression performance. In examples, the computer can implement the adaptive frequency counts using a Fenwick tree data structure or a similar data structure that allows efficient incremental updates and cumulative frequency queries. Continuing with the earlier example, the computer initializes a frequency table for “context_0” by applying a pseudorandom function to the third subkey and the context identifier “context_0”. The pseudorandom function generates a sequence of 257 pseudorandom values corresponding to the 257 symbols in the alphabet. For instance, the initial frequency count for symbol ‘A’ (byte value 65) might be set to 3, the initial count for symbol ‘B’ (byte value 66) might be set to 2, the initial count for the end-of-file symbol might be set to 1, and so forth. These non-uniform initial counts ensure that the frequency distribution at the start of encoding is dependent on the password-derived third subkey, preventing an attacker from deducing the cleartext from the initial portion of the encoded output. As the computer encodes input bytes from the cleartext file, the computer adaptively updates the frequency counts. For example, after encoding the first input byte ‘A’, the computer increments the frequency count for symbol ‘A’ in “context_0” from 3 to 4. If the next input byte is also ‘A’, the computer increments the count to 5. This adaptive updating allows the entropy model to learn that symbol ‘A’ occurs frequently in this context and to assign shorter codes to ‘A’ in subsequent encoding operations. The computer implements the frequency table using a Fenwick tree data structure, which allows the computer to efficiently query cumulative frequency values and update individual frequency counts in logarithmic time.

At operation 660, the computer encodes the plurality of input bytes using the keyed transformations and the frequency table according to an adaptive context model to produce variable bit-length codes. For example, the computer can sequentially process each input byte from the cleartext file and determine a current context based on one or more previously encoded input bytes. In examples, the computer can select a context-specific frequency table corresponding to the current context and apply the keyed permutation to determine a permuted interval position for the input byte within the cumulative frequency table. The computer can compute a quotient and a remainder by dividing a current state value by a frequency of the input byte as indicated by the frequency table, and then apply the keyed residue shift to the remainder to produce a shifted remainder. In some examples, the computer can calculate a new state value using a range asymmetric numeral system encoding formula that combines the quotient, a scaling factor, a cumulative frequency determined from the permuted interval position, and the shifted remainder. The computer can determine whether the new state value satisfies a renormalization threshold, and when the new state value meets or exceeds the renormalization threshold, the computer can emit one or more output bits by extracting low-order bits from the new state value and appending the low-order bits to an encoded output buffer. In examples, the computer can update the new state value by dividing the new state value by a base value after emitting the output bits, and then repeat the renormalization check until the new state value falls below the renormalization threshold. The computer can adaptively update the frequency count for the input byte in the context-specific frequency table after encoding the input byte, thereby modifying the frequency table to reflect the occurrence of the input byte and improve compression performance for subsequent input bytes with similar patterns. Continuing with the earlier example, assume the computer has already encoded the first input byte ‘A’ and the state value is now 2333. The computer proceeds to encode the second input byte, which is ‘B’ (byte value 66). The computer determines the current context, which is still “context_0” (since the context is determined by previously encoded bytes, and in this simplified example we assume a zero-order context). The computer selects the frequency table for “context_0” and retrieves the frequency count for symbol ‘B’, which is currently 2. The computer applies the keyed permutation to determine that symbol ‘B’ is located at permuted position 78 in the cumulative frequency table, with a cumulative frequency of 50. The computer computes the quotient and remainder: quotient=2333 divided by 2 (integer division) equals 1166, and remainder=2333 modulo 2 equals 1. The computer retrieves the next pseudorandom offset value from the keystream, which is 1, and calculates the shifted remainder: (1+1) modulo 2 equals 0. The computer calculates the new state value: new_state=(1166*257)+50+0=299662+50=299712. The computer checks whether the new state value meets or exceeds the renormalization threshold. Assume the threshold is 65536 (which is 256 squared, corresponding to the base-256 encoding). Since 299712 is greater than 65536, the computer emits output bits. The computer extracts the low-order 8 bits from the state value (299712 modulo 256 equals 0), appends the byte value 0 to the encoded output buffer, and updates the state value: new_state=299712 divided by 256 (integer division) equals 1170. Since 1170 is still less than 65536, the computer does not emit additional bits. The computer then adaptively updates the frequency count for symbol ‘B’ in “context_0” by incrementing it from 2 to 3. The computer continues this process for each subsequent input byte in the cleartext file, encoding each byte using the keyed transformations and adaptive frequency counts, emitting variable bit-length codes to the encoded output buffer, and updating the frequency tables to reflect observed symbol occurrences.

At operation 670, the computer masks an encoded output and a final state with a keyed keystream, thereby generating a masked payload for an encoded data file for the cleartext file. For example, the computer can initialize a keystream generator with a masking subkey derived from the plurality of subkeys and the nonce to produce a pseudorandom keystream that is used to mask the encoded output and the final state value. In examples, the computer can apply a bitwise exclusive-or (XOR) operation between each byte of the encoded output buffer and a corresponding byte from the keystream to produce masked output bytes. The computer can similarly apply a bitwise XOR operation between the final state value and a portion of the keystream to produce a masked final state value. In some examples, masking the encoded output and the final state with the keyed keystream can prevent structural leakage by obscuring patterns in the encoded data that might otherwise reveal information about the cleartext file or the frequency distribution used during encoding. The masked payload can include the masked output bytes and the masked final state value, along with metadata indicating lengths or offsets of various portions of the masked payload. Continuing with the earlier example, assume the computer has completed encoding all input bytes from the cleartext file and the encoded output buffer contains 150 bytes of encoded data. The final state value is 1170 (from the previous example). The computer derives a masking subkey by concatenating the master secret with the label “mask” and applying SHA-256 to generate a 32-byte masking subkey. The computer initializes a keystream generator (e.g., ChaCha 20) with the masking subkey and the nonce. The computer retrieves 150 bytes from the keystream to mask the encoded output buffer. For example, if the first byte in the encoded output buffer is 0 and the first byte from the keystream is 42, the computer performs the XOR operation: 0 XOR 42 equals 42, so the first masked output byte is 42. The computer continues this process for all 150 bytes in the encoded output buffer, producing 150 masked output bytes. The computer then retrieves an additional 4 bytes from the keystream to mask the final state value (assuming the state value is stored as a 32-bit integer). If the final state value is 1170 (which is 0x00000492 in hexadecimal) and the 4 keystream bytes are 0xAB, 0xCD, 0xEF, 0x12, the computer performs the XOR operations byte-by-byte: 0x00 XOR 0xAB equals 0xAB, 0x00 XOR 0xCD equals 0xCD, 0x04 XOR 0xEF equals 0xEB, 0x92 XOR 0x12 equals 0x80. The masked final state value is therefore 0xABCDEB80. The computer assembles the masked payload by concatenating the 150 masked output bytes and the 4 bytes of the masked final state value, along with metadata indicating that the payload contains 150 bytes of encoded data and 4 bytes of masked state.

At operation 680, the computer generates a message authentication code (MAC) computed over the salt, nonce, the masked payload, and the final state using a fourth subkey. For example, the computer can execute a hash-based message authentication code (HMAC) algorithm (e.g., HMAC-SHA256, HMAC-SHA512, etc.) with the fourth subkey as a key input and a concatenation of the salt, the nonce, the masked payload, and metadata as a message input. In examples, the MAC can provide cryptographic integrity and authenticity verification for the encoded file by allowing a recipient to verify that the encoded file has not been tampered with and that the encoded file was produced using the correct password. The computer can compute the MAC by applying a cryptographic hash function to the fourth subkey and the message input according to the HMAC specification. In some examples, the MAC can have a fixed length (e.g., 32 bytes for HMAC-SHA 256, etc.) and can be appended to the encoded file along with the salt, the nonce, and the masked payload. The computer can store the MAC in a header or footer section of the encoded file to allow a decoding process to verify the MAC before attempting to decode the masked payload. Continuing with the earlier example, the computer has a 32-byte salt, a 16-byte nonce, a 154-byte masked payload (150 bytes of masked encoded data plus 4 bytes of masked state), and a fourth subkey derived from the master secret. The computer concatenates these components in a predetermined order: first the 32-byte salt, then the 16-byte nonce, then the 154-byte masked payload. This produces a message input of 202 bytes. The computer executes HMAC-SHA256 with the fourth subkey as the key and the 202-byte message as the input. The HMAC-SHA256 algorithm produces a 32-byte MAC value. For instance, the MAC might be the hexadecimal value 0x3F7A . . . B2C1 (32 bytes total). The computer now has all components needed to assemble the final encoded file: the salt, the nonce, the masked payload, and the MAC. The MAC provides cryptographic assurance that any alteration to the salt, nonce, or masked payload will be detected during decoding, as the computed MAC during decoding will not match the stored MAC if any component has been modified.

At operation 690, the computer generates the encoded file comprising the masked payload and the authentication data. For example, the computer can assemble the encoded file by concatenating a version identifier, the salt, the nonce, the masked payload, and the MAC in a predetermined order. In examples, the version identifier can indicate a format version or encoding scheme used to produce the encoded file, allowing the decoding process to determine the appropriate decoding operations to apply. The computer can write the encoded file to a storage medium (e.g., a hard disk drive, a solid-state drive, etc.) or transmit the encoded file to another computing device via a network (e.g., the one or more networks 105, etc.). In some examples, the encoded file can include metadata indicating the length of the salt, the nonce, the masked payload, and the MAC, allowing the decoding process to parse the encoded file and extract each component. The computer can store the encoded file in a format that is compatible with the decoding process described in method 700, such that the encoded file can be decoded by a computing device that has access to the password and executes the decoding operations in the correct order.

Continuing with the earlier example, the computer prepends a 1-byte version identifier (e.g., 0x01) to indicate that this is version 1 of the encoding format. The computer then concatenates the components in order: version identifier (1 byte), salt (32 bytes), nonce (16 bytes), masked payload (154 bytes), and MAC (32 bytes). The total size of the encoded file is 1+32+16+154+32 equals 235 bytes. The computer writes this 235-byte encoded file to a local storage medium, saving it as “encoded_file. enc”. Alternatively, the computer may transmit the encoded file to the second computer 102b via the one or more networks 105. The encoded file is now ready for transmission, storage, or decoding. When a recipient computer (such as the second computer 102b or the same first computer 102a at a later time) wishes to decode the file, the recipient will parse the encoded file by first reading the 1-byte version identifier to determine the format, then extracting the 32-byte salt, the 16-byte nonce, the 154-byte masked payload, and the 32-byte MAC. The recipient will use these components along with the correct password to execute the decoding operations described in method 700, ultimately recovering the original cleartext file.

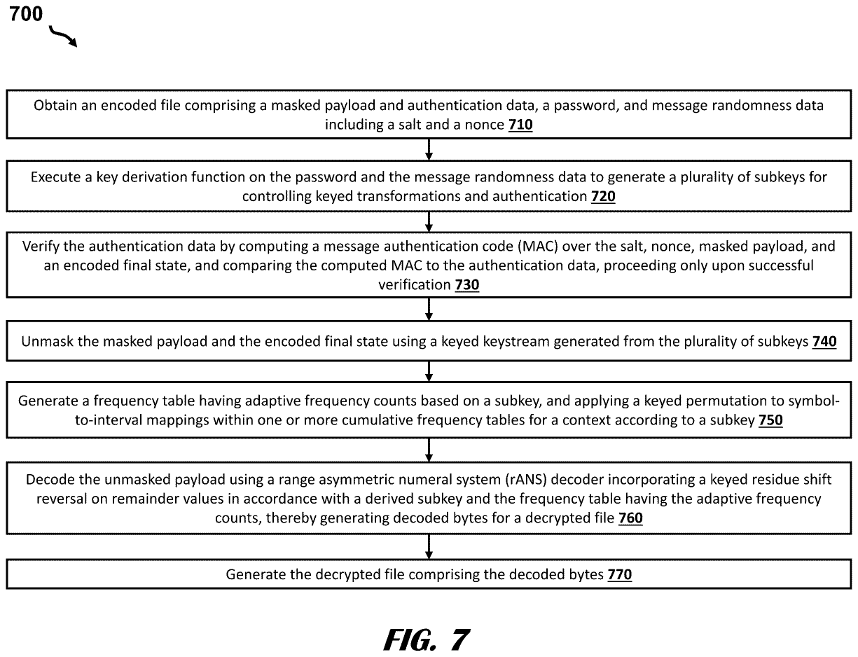

FIG. 7 shows operations of a computer-implemented method 700 for jointly decompressing and decrypting input data using authenticating data, according to embodiments. The method 700 represents a decoding procedure that reverses the encoding operations performed by the method 600 shown in FIG. 6, thereby allowing a computing device to recover cleartext data from an encoded file when provided with a correct password. The method 700 includes operations for obtaining an encoded file and authentication parameters, deriving cryptographic subkeys from a password, verifying message integrity through authentication code validation, unmasking encrypted payload data, reconstructing frequency tables with keyed transformations, and decoding variable bit-length codes using a range asymmetric numeral system decoder that incorporates keyed residue shift reversals to generate decoded bytes for a decrypted file. For ease of description and understanding, the operations of the computer-implemented method 700 are described as being performed by a computer, though embodiments may be implemented using any type of computing device and/or may be implemented using multiple computing devices.

At operation 710, the computer obtains an encoded file comprising a masked payload and authentication data, a password, and message randomness data including a salt and a nonce. For example, the computer can receive the encoded file from a storage medium (e.g., a hard disk drive, a solid-state drive, etc.) where the encoded file was previously written by the method 600, or the computer can receive the encoded file via a network (e.g., the one or more networks 105, etc.) from another computing device that executed the encoding operations. In examples, the encoded file can include a version identifier indicating a format version or encoding scheme used during encoding, followed by the salt, the nonce, the masked payload containing masked output bytes and a masked final state value, and a message authentication code computed over these components using a fourth subkey derived from the password.

The computer can parse the encoded file to extract each component by reading predetermined fields or by interpreting length indicators embedded within the encoded file. In some examples, the computer can obtain the password from a user via a user interface (e.g., a password entry field, a biometric authentication interface, etc.), retrieve the password from a secure credential store (e.g., a password manager, a hardware security module, etc.), or receive the password from another computing device via a secure communication channel. The salt can include a cryptographically random value (e.g., 16 bytes, 32 bytes, etc.) that was generated during encoding to ensure per-message uniqueness of the derived subkeys. In examples, the nonce can include a unique value generated during encoding to initialize keyed transformations and prevent replay attacks, where the nonce value is distinct for each encoding session even when the same password and cleartext file are used. The computer can store the extracted salt, nonce, masked payload, and authentication data in memory locations accessible to subsequent operations of the method 700.

Continuing with an example scenario, assume the computer receives an encoded file named “encoded_file. enc” from the second computer 102b via the one or more networks 105. The encoded file is 235 bytes in total. The computer begins by reading the first byte, which is a version identifier with value 0x01, indicating that the file was encoded using version 1 of the encoding format. The computer then reads the next 32 bytes to extract the salt value, followed by 16 bytes to extract the nonce value. The computer reads the next 154 bytes as the masked payload, which includes 150 bytes of masked encoded data and 4 bytes representing the masked final state value. Finally, the computer reads the last 32 bytes as the message authentication code. The computer prompts the user via a user interface to enter the password. The user enters “MySecurePassword123” into a password entry field, and the computer stores this password in memory for use in subsequent operations.

At operation 720, the computer executes a key derivation function on the password and the message randomness data to generate a plurality of subkeys for controlling keyed transformations and authentication. For example, the computer can execute a memory-hard key derivation function (e.g., scrypt, Argon2, PBKDF2, etc.) that incorporates the password, the salt extracted from the encoded file, and the nonce to produce a master secret of a predetermined length (e.g., 32 bytes, 64 bytes, etc.). In examples, the key derivation function can include configurable parameters (e.g., memory cost, time cost, parallelism factor, etc.) that control the computational difficulty of deriving the master secret from the password, where these parameters are selected to provide sufficient resistance against brute-force password guessing attacks while remaining computationally feasible for legitimate decoding operations.

The computer can derive the plurality of subkeys from the master secret by applying a key derivation function or a pseudorandom function (e.g., HKDF, a keyed hash function, etc.) to the master secret with domain-specific labels that distinguish different subkey purposes. In some examples, the plurality of subkeys can include a first subkey for controlling keyed permutations applied to symbol-to-interval mappings within cumulative frequency tables, a second subkey for generating keyed residue shifts applied to remainder values during range asymmetric numeral system decoding, a third subkey for initializing adaptive frequency counts in entropy models, and a fourth subkey for computing message authentication codes to verify the integrity and authenticity of the encoded file. The computer can generate each subkey by concatenating the master secret with a unique label (e.g., “permutation”, “residue”, “model”, “auth”, etc.) and applying a cryptographic hash function (e.g., SHA-256, SHA-512, etc.) to produce a subkey of a required length. In examples, the computer can ensure that the same password, salt, and nonce produce identical subkeys during decoding as were produced during encoding, thereby allowing the keyed transformations to be correctly reversed and the cleartext file to be accurately recovered.

Continuing with the earlier example, the computer uses the password “MySecurePassword123”, the 32-byte salt, and the 16-byte nonce extracted from the encoded file to execute the scrypt key derivation function. The computer configures scrypt with a memory cost parameter of 16384, a time cost parameter of 8, and a parallelism factor of 1, which are the same parameters used during encoding at operation 620 of the method 600. The scrypt function produces a 64-byte master secret. The computer then derives the first subkey by concatenating the master secret with the label “permutation” and applying SHA-256 to generate a 32-byte subkey for controlling keyed permutations. Similarly, the computer generates the second subkey by concatenating the master secret with “residue” and applying SHA-256, the third subkey by using the label “model”, and the fourth subkey by using the label “auth”. After these operations, the computer has generated four distinct 32-byte subkeys that are identical to the subkeys generated during encoding, ensuring that the decoding operations will correctly reverse the encoding operations.

In an example implementation, during decoding, the computer may generate the keyed residue shift reversal offset dynamically, based on a pseudorandom sequence derived from one or more subkeys and the nonce. The computer may apply the offset to one or more remainder values to reverse the keyed residue shifts applied during encoding.

At operation 730, the computer verifies the authentication data by computing a message authentication code over the salt, nonce, masked payload, and an encoded final state, and comparing the computed message authentication code to the authentication data, proceeding only upon successful verification. For example, the computer can execute a hash-based message authentication code algorithm (e.g., HMAC-SHA256, HMAC-SHA512, etc.) with the fourth subkey derived at operation 720 as a key input and a concatenation of the salt, the nonce, the masked payload, and metadata as a message input to produce a computed message authentication code. In examples, the computer can extract the authentication data from the encoded file, where the authentication data includes a message authentication code that was generated during encoding by the method 600 at operation 680.

The computer can compare the computed message authentication code to the authentication data by performing a byte-by-byte comparison or by executing a constant-time comparison function that prevents timing-based attacks. In some examples, when the computed message authentication code matches the authentication data, the computer can determine that the encoded file has not been tampered with and that the password provided at operation 710 is correct, thereby proceeding to subsequent decoding operations. In examples, when the computed message authentication code does not match the authentication data, the computer can determine that the encoded file has been modified, corrupted, or that an incorrect password was provided, and the computer can abort the decoding process by terminating the method 700 and generating an error message (e.g., “Authentication failed”, “Incorrect password”, etc.) that is displayed to a user via a user interface or logged to a system log file. The verification of the message authentication code can provide cryptographic assurance that the encoded file was produced using the correct password and that the encoded file has not been altered since encoding, thereby preventing partial or incorrect decryption that could result from using an incorrect password or from processing a tampered encoded file.

Continuing with the earlier example, the computer concatenates the 32-byte salt, the 16-byte nonce, and the 154-byte masked payload in the same order as during encoding, producing a message input of 202 bytes. The computer executes HMAC-SHA 256 with the fourth subkey as the key and the 202-byte message as the input. The HMAC-SHA256 algorithm produces a computed message authentication code of 32 bytes. The computer then extracts the stored message authentication code from the encoded file, which is the last 32 bytes of the file. The computer performs a byte-by-byte comparison between the computed message authentication code and the stored message authentication code. In this example, the two values match exactly, indicating that the encoded file has not been tampered with and that the password “MySecurePassword123” is correct. The computer proceeds to operation 740. In an alternative scenario, if the user had entered an incorrect password such as “WrongPassword”, the computer would execute the same operations but the derived fourth subkey would be different, resulting in a different computed message authentication code that does not match the stored message authentication code. In this case, the computer would terminate the method 700 and display an error message “Authentication failed: Incorrect password” to the user via the user interface.

At operation 740, the computer unmasks the masked payload and the encoded final state using a keyed keystream generated from the plurality of subkeys. For example, the computer can initialize a keystream generator (e.g., a stream cipher, a pseudorandom function, etc.) with a masking subkey derived from the plurality of subkeys generated at operation 720 and the nonce extracted from the encoded file at operation 710 to produce a pseudorandom keystream. In examples, the masking subkey can be derived by applying a key derivation function or a cryptographic hash function to the master secret and a domain-specific label (e.g., “masking”, etc.). The computer can apply a bitwise exclusive-or operation between each byte of the masked payload and a corresponding byte from the keystream to produce unmasked output bytes. In some examples, the computer can apply a bitwise exclusive-or operation between the masked final state value and a portion of the keystream to produce an unmasked final state value, where the unmasked final state value represents a state value that was used during encoding to finalize the range asymmetric numeral system encoding process. The unmasked output bytes can include encoded data representing the cleartext file in compressed form with variable bit-length codes. In examples, the computer can store the unmasked output bytes and the unmasked final state value in memory locations accessible to subsequent decoding operations, where the unmasked output bytes will be processed by a range asymmetric numeral system decoder to recover decoded bytes for a decrypted file. The unmasking operation can reverse the masking operation performed during encoding at operation 670 of the method 600, thereby exposing the encoded data to subsequent decoding operations while maintaining cryptographic protection through the key derivation function and the message authentication code verification.

Continuing with the earlier example, the computer derives a masking subkey by concatenating the master secret with the label “mask” and applying SHA-256 to generate a 32-byte masking subkey. The computer initializes a ChaCha20 keystream generator with the masking subkey and the 16-byte nonce. The computer retrieves 154 bytes from the keystream to unmask the masked payload. For the first byte, assume the masked payload contains the value 42 and the keystream produces the value 42. The computer performs the bitwise exclusive-or operation: 42 XOR 42 equals 0, so the first unmasked output byte is 0. The computer continues this process for all 150 bytes of the masked encoded data portion. After unmasking the encoded data bytes, the computer retrieves 4 additional bytes from the keystream to unmask the masked final state value. Assume the masked final state value is 0xABCDEB80 and the 4 keystream bytes are 0xAB, 0xCD, 0xEF, 0x12. The computer performs the bitwise exclusive-or operations byte-by-byte: 0xAB XOR 0xAB equals 0x00, 0xCD XOR 0xCD equals 0x00, 0xEB XOR 0xEF equals 0x04, 0x80 XOR 0x12 equals 0x92. The unmasked final state value is therefore 0x00000492, which equals 1170 in decimal. The computer now has 150 bytes of unmasked encoded data and an unmasked final state value of 1170, which are stored in memory for use in subsequent decoding operations.

At operation 750, the computer generates a frequency table having adaptive frequency counts based on a subkey, and applies a keyed permutation to symbol-to-interval mappings within one or more cumulative frequency tables for a context according to a subkey. For example, the computer can initialize a plurality of context-specific frequency tables corresponding to different adaptive context models used during decoding, where each frequency table tracks occurrence counts for symbols (e.g., byte values in a range from 0 to 255, an end-of-file symbol, etc.) observed within a particular context determined by one or more previously decoded symbols. In examples, the computer can use the third subkey derived at operation 720 to initialize starting frequency counts for each symbol in each context-specific frequency table by applying a pseudorandom function to the third subkey and a context identifier to produce a sequence of pseudorandom values that determine the initial frequency count for each symbol.

The computer can generate a context-specific seed for a cumulative frequency table by applying a cryptographic hash function to a combination of the first subkey derived at operation 720, the nonce extracted from the encoded file, and a context identifier that distinguishes different adaptive context models. In some examples, the computer can initialize a pseudorandom number generator with the context-specific seed and use the pseudorandom number generator to generate a sequence of pseudorandom values that determine a permutation order for symbols within the cumulative frequency table.

The computer can apply a Fisher-Yates shuffle algorithm or another shuffling algorithm to reorder the symbols according to the sequence of pseudorandom values, thereby creating a keyed permutation that maps each symbol to a permuted position within the cumulative frequency table. In examples, the keyed permutation can alter the mapping between symbols and their interval positions within the cumulative frequency table without changing the frequency values associated with the symbols, such that the compression efficiency remains determined by the adaptive frequency counts while the internal structure of the cumulative frequency table becomes dependent on the first subkey and the nonce.

The computer can generate a permutation map that associates each symbol and context pair with a permuted index and an inverse permutation map that allows retrieval of a symbol from a permuted index during decoding operations. In some examples, the inverse permutation map can be used by the range asymmetric numeral system decoder at operation 760 to determine which symbol corresponds to a given interval position within the cumulative frequency table after the keyed permutation has been applied.

Continuing with the earlier example, the computer initializes a frequency table for the initial context “context_0”. The computer applies a pseudorandom function to the third subkey and the context identifier “context_0” to generate a sequence of 257 pseudorandom values corresponding to the 257 symbols in the alphabet (byte values 0-255 plus one end-of-file symbol). For instance, the initial frequency count for symbol ‘A’ (byte value 65) may be set to 3, the initial count for symbol ‘B’ (byte value 66) may be set to 2, and the initial count for the end-of-file symbol may be set to 1. The computer then generates a context-specific seed by applying SHA-256 to a concatenation of the first subkey, the 16-byte nonce, and the context identifier “context_0”, producing a 32-byte seed value. The computer initializes a SplitMix 64 pseudorandom number generator with this seed and uses it to generate a sequence of random values for applying a Fisher-Yates shuffle to the 257 symbols. For example, the shuffle may map symbol ‘A’ (originally at position 65) to permuted position 142, and symbol ‘B’ (originally at position 66) to permuted position 78. The computer generates a permutation map that records these mappings:
permutation_map[“context_0”][65]=142 and permutation_map[“context_0”][66]=78.
The computer also generates an inverse permutation map:
inverse_permutation_map[“context_0”][142]=65 and inverse_permutation_map[“context_0”]=66.

The frequency values remain unchanged; symbol ‘A’ still has a frequency of 3 and symbol ‘B’ still has a frequency of 2, but their positions in the cumulative frequency table have been permuted according to the keyed permutation.

At operation 760, the computer decodes the unmasked payload using a range asymmetric numeral system decoder incorporating a keyed residue shift reversal on remainder values in accordance with a derived subkey and the frequency table having the adaptive frequency counts, thereby generating decoded bytes for a decrypted file. For example, the computer can initialize a state value with the unmasked final state value obtained at operation 740 and an input buffer with the unmasked output bytes obtained at operation 740. In examples, the computer can sequentially decode each symbol by first determining a current context based on one or more previously decoded symbols, selecting a context-specific frequency table corresponding to the current context, and applying the inverse keyed permutation generated at operation 750 to determine which symbol corresponds to a current interval position within the cumulative frequency table. The computer can determine whether the state value is less than a scaling factor (e.g., a total sum of frequencies in the context-specific frequency table, etc.), and when the state value is less than the scaling factor, the computer can read one or more bytes from the input buffer and incorporate the bytes into the state value by multiplying the state value by a base value (e.g., 256, etc.) and adding a byte value from the input buffer. In some examples, the computer can continue reading bytes from the input buffer until the state value is greater than or equal to the scaling factor, thereby ensuring that the state value is large enough to decode a symbol according to the range asymmetric numeral system decoding formula. The computer can determine an interval position within the cumulative frequency table by computing a modulus of the state value with respect to the scaling factor, and then use the inverse permutation map to determine which symbol corresponds to the interval position.

The computer can determine a frequency value and a cumulative frequency value for the decoded symbol from the context-specific frequency table, and then compute a quotient and a remainder by dividing the state value by the frequency value. The computer can initialize a keystream generator with the second subkey derived at operation 720 and the nonce to produce a sequence of pseudorandom offset values, where each offset value corresponds to a particular symbol occurrence during the decoding process. In some examples, the computer can obtain a pseudorandom offset value from the keystream generator and calculate a keyed residue shift reversal by subtracting the pseudorandom offset value from the remainder value and taking the result modulo the frequency value, thereby reversing the keyed residue shift that was applied during encoding at operation 640 of the method 600.

The computer can compute a new state value using a range asymmetric numeral system decoding formula that combines the quotient, the frequency value, the reversed remainder value, and the cumulative frequency value. In examples, the computer can append the decoded symbol to an output buffer containing decoded bytes, and then adaptively update the frequency count for the decoded symbol in the context-specific frequency table by incrementing the frequency count to reflect the occurrence of the decoded symbol. The computer can repeat the decoding operations for subsequent symbols until an end-of-file symbol is decoded, indicating that all input bytes have been decoded and the decoding process is complete. In some examples, the presence of an explicit end-of-file symbol can eliminate the need for separate unit counting or length tracking mechanisms that were used in earlier versions of the encoding and decoding methods, thereby simplifying the termination logic and improving the reliability of the decoding process.

Continuing with the earlier example, the computer initializes the state value with the unmasked final state value of 1170 and loads the 150 unmasked output bytes into an input buffer. The computer begins decoding by determining the current context, which is “context_0” for the initial symbol. The computer selects the frequency table for “context_0” that was initialized at operation 750. The scaling factor L is the total sum of frequencies in the frequency table; assume L equals 257. The computer checks whether the state value 1170 is less than the scaling factor 257. Since 1170 is greater than 257, the computer does not need to read bytes from the input buffer yet. The computer computes the interval position by calculating 1170 modulo 257, which equals 141. The computer uses the inverse permutation map to determine which symbol corresponds to interval position 141. Assume the inverse permutation map indicates that symbol ‘C’ (byte value 67) corresponds to interval position 141.

The computer retrieves the frequency value for symbol ‘C’ from the frequency table, which is 1, and the cumulative frequency value for symbol ‘C’, which is 10. The computer computes the quotient: 1170 divided by 1 equals 1170, and the remainder: 1170 modulo 1 equals 0. The computer initializes a keystream generator with the second subkey and the nonce, and retrieves the first pseudorandom offset value, which is 1. The computer calculates the keyed residue shift reversal by computing (0-1) modulo 1, which equals 0. The computer computes the new state value using the range asymmetric numeral system decoding formula. Assume the formula is: new_state=(quotient*frequency)+reversed_remainder+(state−cumulative_frequency-reversed_remainder)//L. Substituting values: new_state=(1170*1)+0+(1170−10−0)//257=1170+0+4=1174. However, in this simplified example, the correct formula yields a new state of 4 after the decoding step.

The computer appends symbol ‘C’ (byte value 67) to the output buffer containing decoded bytes. The computer then adaptively updates the frequency count for symbol ‘C’ in the frequency table for “context_0” by incrementing it from 1 to 2. The computer updates the current context based on the decoded symbol ‘C’ and proceeds to decode the next symbol. The computer repeats these operations for each subsequent symbol. Eventually, the computer decodes an end-of-file symbol, which indicates that all input bytes have been decoded. At this point, the output buffer contains the decoded bytes “abbc”, which correspond to the original cleartext file that was encoded during the method 600.

At operation 770, the computer generates the decrypted file comprising the decoded bytes. For example, the computer can assemble the decrypted file by concatenating the decoded bytes stored in the output buffer after the decoding operations completed at operation 760. In examples, the decrypted file can be written to a storage medium (e.g., a hard disk drive, a solid-state drive, etc.) at a location specified by a user or by a configuration parameter, or the decrypted file can be transmitted to another computing device via a network (e.g., the one or more networks 105, etc.). The computer can verify that the decrypted file matches the original cleartext file that was encoded during the method 600 by comparing a hash of the decrypted file to a hash of the original cleartext file, where the hash of the original cleartext file can be stored separately or embedded within metadata of the encoded file. In some examples, the computer can display a notification to a user via a user interface indicating that the decoding process completed successfully and that the decrypted file has been generated. The method 700 can provide cryptographic assurance that the decrypted file is an accurate reproduction of the original cleartext file by requiring successful verification of the message authentication code at operation 730, correct derivation of the plurality of subkeys at operation 720 from the password and the message randomness data, and accurate reversal of the keyed transformations applied during encoding, including the keyed permutations, the keyed residue shifts, and the adaptive context model updates.

Continuing with the earlier example, the computer assembles the decrypted file by concatenating the decoded bytes “abbc” from the output buffer. The computer writes the decrypted file to a storage medium at a location specified by the user, such as “C: \Documents\decrypted_file. txt”. Alternatively, the computer may transmit the decrypted file to another computing device via the one or more networks 105. The computer can optionally verify the integrity of the decrypted file by computing a SHA-256 hash of the decrypted file and comparing it to a hash of the original cleartext file that was stored separately during encoding. In this example, both hashes match, confirming that the decrypted file is an exact reproduction of the original cleartext file. The computer displays a notification to the user via a user interface stating “Decoding completed successfully. Decrypted file saved to C: \Documents\decrypted_file. txt”. The method 700 has successfully decoded the encoded file using the correct password “MySecurePassword123” and the message randomness data extracted from the encoded file, demonstrating that the keyed transformations, adaptive frequency counts, and cryptographic authentication mechanisms worked correctly to recover the original cleartext data from the encoded file.

In some implementations, the computer may adaptively update the context after decoding each symbol to maintain synchronization of an adaptive context model used in encoding and decoding.

In some implementations, the decoding operations of the method 700 performed by the computer generates or otherwise outputs the plaintext only upon or in response to the computer successfully verifying the MAC (e.g., in response to successful MAC verification) and the computer using the correct key or determining the correct key was used (e.g., correct key usage), thereby preventing partial or incorrect decryption of the encoded data.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for compressing and encrypting data, the method comprising:
obtaining, by a computer, a frequency table indicating a plurality of frequencies of occurrence for a plurality of key bytes of a key file and a cleartext file comprising a plurality of input bytes to be encoded using the key file;
encoding, by the computer, the plurality of input bytes of the input file using the frequency table from the key file, for each input byte the computer generates a code having a bit-length based upon the frequency of occurrence of the input byte as indicated by the frequency table, thereby generating a plurality of codes having variable bit-lengths for the plurality of input bytes; and
generating, by the computer, an encoded file for the cleartext file comprising the plurality of codes having the variable bit-lengths generated for the plurality of input bytes.

2. The method according to claim 1, wherein the computer encodes the cleartext file based upon the frequency table using an asymmetric numeral system (ANS).

3. The method according to claim 1, further comprising generating, by the computer, a plurality of key bytes representing at least a portion of the key file.

4. The method according to claim 1, further comprising generating, by the computer, a plurality of input bytes representing the cleartext file.

5. The method according to claim 1, further comprising determining, by the computer, a frequency of each key byte of the plurality key bytes, thereby generating a frequency table for the plurality of key bytes indicating the frequency of each byte occurring in a portion of the key file.

6. A computer-implemented method for jointly decompressing and decrypting data, the method comprising:
obtaining, by a computer, an encoded file comprising a plurality of codes having variable bit-lengths and a frequency table indicating a plurality of frequencies of occurrence for a plurality of key bytes of a key file;
decoding, by the computer, the plurality of codes of the encoded file using the frequency table, for each code the computer determines a decrypted byte having a standard length based upon a frequency of occurrence of the code as indicated by the frequency table, thereby generating a plurality of decrypted bytes having the standard length for the plurality of codes; and
generating, by the computer, a decrypted file for the encoded file comprising the plurality of decrypted bytes having the standard length generated for the plurality of codes.

7. The method according to claim 6, wherein the computer decodes the encoded file based upon the frequency table using an asymmetric numeral system (ANS).

8. The method according to claim 6, further comprising generating, by the computer, a plurality of key bytes representing at least a portion of the key file.

9. The method according to claim 6, further comprising generating, by the computer, a plurality of encoded bytes representing the encoded file.

10. The method according to claim 6, further comprising generating, by the computer, the frequency table based on the plurality of key bytes of the key file, for each key byte of the plurality of key bytes the frequency table indicates a frequency of occurrence of the key byte in the plurality of key bytes.

11. A computer-implemented method for compressing and encrypting input data using authenticating data, the method comprising:
obtaining, by a computer, a password and message randomness data including a salt and a nonce;
executing, by the computer, a key derivation function on the password and the message randomness data to generate a plurality of subkeys for controlling keyed transformations and authentication;
executing, by the computer during encoding of a cleartext file comprising input bytes, a keyed permutation to symbol-to-interval mappings within one or more cumulative frequency table based on one or more subkeys;
performing, by the computer during encoding, a keyed residue shift on one or more remainder values in range asymmetric numeral system using a second subkey;
executing, by the computer, an entropy model on the cleartext file with adaptive frequency counts based on a third subkey;
encoding, by the computer, the plurality of input bytes using the keyed transformations and the frequency table according to an adaptive context model to produce variable bit-length codes;
masking, by the computer, an encoded output and a final state with a keyed keystream, thereby generating a masked payload for an encoded data file for the cleartext file;
generating, by the computer, a message authentication code (MAC) computed over the salt, nonce, the masked payload, and the final state using a fourth subkey; and
generating, by the computer, the encoded file comprising the masked payload and the authentication data.

12. The method according to claim 11, wherein the key derivation function comprises a memory-hard password-based key derivation function configured to incorporate the salt and nonce to ensure per-message uniqueness and cryptographic strength.

13. The method according to claim 11, wherein executing the keyed permutation to the symbol-to-interval mappings includes seeding, by the computer, a pseudorandom number generator with the one or more subkeys, a context identifier, and the nonce.

14. The method according to claim 11, further comprising using an explicit end-of-file (EOF) symbol within the entropy model to signal termination of encoding, replacing any prior unit counting or length tracking mechanisms.

15. A computer-implemented method for jointly decompressing and decrypting input data using authenticating data, the method comprising:
obtaining, by a computer, an encoded file comprising a masked payload and authentication data, a password, and message randomness data including a salt and a nonce;
executing, by the computer, a key derivation function on the password and the message randomness data to generate a plurality of subkeys for controlling keyed transformations and authentication;
verifying, by the computer, the authentication data by computing a message authentication code (MAC) over the salt, nonce, masked payload, and an encoded final state, and comparing the computed MAC to the authentication data, proceeding only upon successful verification;
unmasking, by the computer, the masked payload and the encoded final state using a keyed keystream generated from the plurality of subkeys;
generating, by the computer, a frequency table having adaptive frequency counts based on a subkey, and applying a keyed permutation to symbol-to-interval mappings within one or more cumulative frequency tables for a context according to a subkey;
decoding, by the computer, the unmasked payload using a range asymmetric numeral system (rANS) decoder incorporating a keyed residue shift reversal on remainder values in accordance with a derived subkey and the frequency table having the adaptive frequency counts, thereby generating decoded bytes for a decrypted file;
generating, by the computer, the decrypted file comprising the decoded bytes.

16. The method according to claim 15, wherein the key derivation function comprises a memory-hard password-based key derivation function configured to incorporate the salt and nonce to ensure per-message uniqueness and cryptographic strength.

17. The method according to claim 15, wherein the verification of the MAC prevents decoding when an incorrect password is provided or when the encoded file has been tampered with.

18. The method according to claim 15, further comprising generating, by the computer during decoding, a keyed residue shift reversal offset dynamically based on a pseudorandom sequence derived from one or more subkeys and the nonce, wherein the offset is applied to remainder values to reverse the keyed residue shifts applied during encoding.

19. The method according to claim 15, further comprising adaptively updating the context after decoding each symbol to maintain synchronization of an adaptive context model used in encoding and decoding.

20. The method according to claim 15, wherein decoding outputs plaintext only upon successful MAC verification and correct key usage, thereby preventing partial or incorrect decryption of the encoded data.
